(19) United States
(12) Patent Application Publication
(10) Pub. No.: US 2010/0306034 A1
(43) Pub. Date: Dec. 2, 2010

(54) System & method for facilitating projected transactions

(76) Inventors: Jeff Stein, St. Louis, MO (US); Tom Tham, Chesterfield, MO (US)

Correspondence Address: KLOTZER PATENTS, 4579 LACLEDE AVE, # 210, ST. LOUIS, MO, 63108, US

(21) Appl. No.: 12/800,293

(22) Filed: May 12, 2010

Related U.S. Application Data
(60) Provisional application No. 61/216,211, filed on May 13, 2009.

(51) Int. Cl. G06Q 10/00; G06Q 30/00; G06Q 90/00

(52) U.S. Cl. 705/10; 705/500

(57) ABSTRACT

The present invention provides various capabilities of facilitating projected transactions by managing accounts, projections, and incentives. Features of the various embodiments of the present invention include multiple access options, comprising web mediated interactions and provisionings of compilations of projections and incentives in conjunction with transaction venues, among others. Other features include identifying of incentives related to account associated projections, appraising and comptrolling of incentive benefits, and assessing of projections, incentives, and their various realization statuses. Provisionings of projections and/or incentives will be often venue focused, with substantial degrees of projection and/or incentive compilation customization, modification, and/or provisionings available when accessing an interaction facility via multiple modes.

### CROSS-REFERENCE TO RELATED APPLICATIONS

This application is a continuation of and claims the benefit of the priority date of U.S. Provisional Application Ser. No. 61/216,211, filed May 13, 2009, the entire disclosure of which is hereby incorporated herein by reference.

### STATEMENT REGARDING FEDERALLY SPONSORED RESEARCH OR DEVELOPMENT

Not applicable.

### BACKGROUND OF THE INVENTION

1. Field of the Invention

The present invention relates to systems and methods for facilitating projected transactions such as consumer shopping purchases, and more particularly to systems and methods for providing various combinations of Web, e-commerce, mobile communication, fixed on-site access points, data mining, cloud computing & data storage, as well as third party resource interoperability to facilitate projected transactions.

2. Related Art

Virtually all modem economic systems entail numerous transactions involving exchanges of value between at least two parties. In the vast majority of these transactions, a variety of options are available for at least one, and often all, of these parties, should they prefer. In particular with regard to consumers, for most goods and/or services, the provider must make a commitment of resources towards producing the goods and/or services prior to certainty that the consumer demand will be sufficient to appropriately compensate the provider. Even the avoidance of substantial inventory, which may have many benefits such as reduced resource stasis, will also produce potential problems, such as the need to invest major resources towards the establishment of robust production facilities, since a large demand will need to be produced fast, given that there is only minimal inventory available. Hence, producers have a strong need to understand and forecast consumer interests, for planning purposes, as well as a core objective of communicating convincingly with consumers to influence the consumer to select their transaction over that of another party, once they are executing their plan. Contrastingly, consumers lack the resources, most usually in terms time and/or money, to fully capture every potential advantage available for every individual good and/or service that they transact for, unlike the producer which has a much greater share of their resources invested in a given product, and hence these producers generally concentrate much larger efforts towards the marketing of each individual product than consumers do, for example, towards finding the optimal transaction for each and every item on a shopping list.

The prevailing approach to marketing that has been employed hereto now is analogous to hunters embarking on a safari. Just as the hunters would employ guides and utilize evidence of tracks gleaned from observing the past behavior of the quarry, much current marketing efforts involve capturing and/or analyzing past purchasing actions and, in combination with the objectives of the providers of the goods and/or services, tactics are devised that are intended to capture the interest, and hopefully the resources, of the quarry (i.e. consumers.) These approach are sometimes utilized in concert with various attempts to glean consumer feedback in the interest of improving the tactics employed by the marketers and/or providers. There is, of course, inherent inaccuracies due to selection bias among those who decide to feedback and a lack of control over a variety of other biases such as, for example, a consumer's greater propensity for self-selection to give feedback when they have a particularly strong reaction to some good and/or service. Generally lacking in these marketing strategies are substantial advantages to the consumers, other than specific provider supplied incentives and/or enticements, and even they are essentially present in accordance with the providers' needs and objectives, not the consumers', other than the providers' attempts to divine what the consumer wants well enough to be able to shape their actions. A paradigm with an alternative focus that stems from the consumer end of the transaction, and is oriented towards their objectives, is generally available only in a piecemeal fashion for consumers, since the prevailing paradigms do not generally consider the consumers' interests to be of greater, or even equivalent importance as the interests of those doing the providing and/or marketing.

A consumer-centric paradigm alters many of the existing standard marketing approaches, from provider-centric approach that employ a panoply of individual tactics preferred by various providers (i.e. a discount here, a rebate there, or an extended warranty further down the block) that are at least tolerated (hopefully) by the consumers, to approaches that are actively configured around the consumers' interests and objectives, which providers can then participate in and learn from. Presently, conventional marketing approaches look to study and understand the consumer from the outside and often incorporate a degree of, if not suspicion, at least skepticism in regard to the benefits to be gained from actively encouraging consumer input to marketing decision-making (e.g. a marketing attitude that assumes about consumers that: “They want lower prices, big surprise.”) With the ever increasing predominance of Internet mediating, and in particular World Wide Web (usually denoted herein as “Web”) mediating of transaction related communication and investigation efforts on both the consumer and the provider sides, an order of magnitude increase in the tools, information access, interaction capabilities, and analyzable data has been presented to marketers. As in many areas of endeavor, the pace of change enacted by the coming of the Internet age is greater than the pace of evolution of marketing tactics or the development of new paradigms that move marketing away from just adapting old approaches to new (Internet mediated) channels, into embraces of substantially different arrangements in which marketing muscle is gleaned by first providing power to the consumer, and then essentially partnering with their collective interests to gain back marketing benefits from their participation and even their active encouragement.

### SUMMARY OF THE INVENTION

Among the more notable embodiments of the present invention are those that are focused on the typical home consumer that regularly buys groceries, sees a movie, or shops for shoes, but it should be understood that as used herein, the term consumer does encompass those individuals, but is not limited to them. One of the broadest meanings of the term stems from the field of Economics, wherein the scope of the term “consumer” broadly encompasses any person or organization that uses a commodity or service and this sense is also applicable herein. In other words, as used herein a consumer can be essentially any entity that can participate in a transaction for any commodity or service. Large portions of the descriptions herein of embodiments of the present invention are directed towards transactions involving those referred to by the term “consumer”, and in particular, many of the details and uses explicated are illustrative and/or tailored to retail consumer experiences. It should be understood though, that while these retail-consumer oriented descriptions are representative of at least some of the embodiments of the present invention, they are not limiting in the sense that the retail consumer experience is not the sole situation to which they are applicable, but rather the combinations of functionalities which may be of particular advantage to retail consumers are also well employable in other circumstances, and the scope of the present invention also encompasses those utilities as well. Additionally, although the term “transaction” as used herein does include typical purchases and the like made in the retail consumer environment, it is not limited to those circumstances. In general, there are few limits on what type of transaction that can be facilitated by the present invention, other than a need for at least one transaction related attribute to have at least one mode with at least one consumer option available, including an option of whether or not to facilitate the transaction.

A first cardinal characteristic of many embodiments of the present invention is their focus on projected transactions, i.e. plans and/or intentions. Future transactions can be subdivided according to whether or not they are anticipated by the consumer. There is considerable potential to beneficially facilitate those transactions that are anticipated and/or intended. Therefore, a chief objective of many embodiments of the present invention is providing capabilities for facilitating (1) projection developing wherein, among other things, consumers plan, organize, seek savings, and provide varying degrees of access to their projections; as well as (2) projection executing wherein, among other things, consumers access their developed projections, effect the projections, apply their savings (and other benefits), reconfigure projections in accordance with the just executed projections, and develop new projections. A first aspect of certain embodiments of the present invention enables consumers, depending on their capabilities, to generally interact with at least some aspects of embodiments of the present invention by varying, and frequently electronic, communication channels. These key manners of communication include, but are not limited to, at least one of Web access, e-mail access, mobile communication access, audio channels (such as telephonic communication), and distributed fixed access points (such as an interactive kiosk at a grocery store.) Most embodiments of the present invention will involve at least one form of what is commonly referred to as cloud computing and storage, wherein at least one site that is physically non-local, i.e. not within the immediate location and individual possession of the consumer, maintains data storage and computing capabilities for performing the present invention's systems and methods. Much of the means in which these systems and methods are performed, in terms of computing hardware, operational software, and communication infrastructure, are widely available means that are well known to those of skill in the art. In many cases, the hardware, software, and infrastructure will involve industry standard Internet, database storage and access, application logic, and user interface approaches.

The consumer-centric orientation for consumer users of embodiments of the present invention is arranged to provide the consumer functionalities that facilitate their objectives in accordance with their priorities. For example, rather than providing a single coupon for a competing product, after a different product has already been purchased, systems according to the present invention will provide access to a number of potential offers that are matched to the consumer's transaction intentions that are inputted as projected purchases for that consumer's account. At the heart of many embodiments of the present invention is an incentive seeking and distributing component that, in response to consumer users' projected transaction inputs, finds and apportions incentives, such as discount coupons, in accordance with the consumer users' projections (most commonly inputted via a web interface.) Often, more than one incentive may be available for a given projection, and the consumer user usually will then be able to pick and choose among the available offers. Additional selection affecting options can also be made available, such as sorting incentives in relation to geographic considerations, projected transaction repetition or scale, preferences in providers patronized, and temporal issues (such as determining that an incentive is desired for a transaction that is planned during a certain future time period.) Consumer users can access the present system in variety of ways when in the vicinity of a retail participant, including mobile communications devices, but will perhaps most regularly utilize a kiosk which enables consumer users to have access to the cloud storage and interactional capabilities of the system from a device resident in the vicinity of the retail participant. (It should be noted also, that when discussing vicinities not only is the term “vicinity” applicable to geographical closeness, but also virtual closeness such as when shopping on-line at a web retailer. In the case of web retailers, closeness can be defined as any identifier, whether expressed explicitly or present in metadata, that indicates a retailer web site has been accessed or enquired about. When such virtual closeness has been found the system can open a widget, perhaps being represented as a kiosk, or similar functionality that enables use of the transaction facilitating at the virtual retailer as well.) Collaborative aspects of the transaction facilitating can also be enabled for consumers, so that various forms of social networking can participate in finding, organizing, and leveraging incentives that may be of group interest.

Commonly, retail consumer users will create an account on a web-based site that maintains an application that provides access to the system's functions, including:
a) Creating an account, wherein they will store there individual data, preferences, etc.;
b) Building at least one shopping list by, among other ways, choosing items form categorical listings or just entering the list information that can then be parsed with an intelligent dictionary;
c) Preview and/or select from incentives and other list-related offerings that providers may want the retail consumer user to consider;
d) Presentation of advertising and or previews of provider offerings; and
e) Review their history of transaction facilitations, including price savings, redemption-related information (such as mail-in rebate time requirements).
   Also very commonly, retail consumer users will utilize a retail participant vicinity kiosk, which can generally access the present system's cloud computing and storage capabilities, for various functions, including:
a) Accessing their account, routinely via an individual identification like a user name or by inputting a physical identifier like a credit card;
b) Reviewing, selecting from, and, optionally, interacting with, their projected transaction lists for an assortment of purposes such as selecting the appropriate list for a given retailer;
c) Printing, communicating, or downloading their lists; and
d) Editing, including populating, their lists with offers, such as new offers that may be recently available and or specific to a particular retail location.
   Among the capabilities thereby afforded to retail consumer users are:
a) Pervasively accessible projected transaction lists, hence avoiding difficulties in maintaining access to a specific physical list that targets at least one specific transaction at one specific retailer and/or that relates to at least one specific incentive whenever or wherever needed;
b) Sharable projected transaction lists, so that a consumer, for example, that stops off after his work to purchase groceries and accesses a kiosk according to the present invention can receive a projected transaction list that already includes the intended transactions entered by his wife from her workplace, as well as incentive options that are associated with her intended transactions;
c) Automatic projected transaction list incorporation, without need for separate items, of incentives associated with the contents of the list, regularly including manners of incorporation, such as projected transaction associated bar code inclusions, that are readily acceptable to a provider of the contents of the projected transaction list;
d) Alternate projected transaction proposing, such as suggesting a purchase of sausage rather than bacon, including, in particular, propositions that are associated with specific incentives; and optionally
e) Projected transaction aggregation related functions, such as maintenance of projected transaction records for frequency awards programs and/or savings accumulation accounts.
   Among the capabilities concomitantly offerable to providers are a range of forms of information and participation programs based on consumers' actual active plans, intentions, and projections rather than solely extrapolating, inferring, deducing, or estimating consumers' desires from past actions that are generally shaped by a multitude of factors besides consumers' intentions.

Representative instances of various realizations of the present invention can comprise varying combinations of elements and limitations. Among the combinations that comprise these representative instances are:

A first system for facilitating projected transactions comprising (A) an account administrator that manages accounts, transaction projections, and transaction incentives, including managing by associating projections with accounts, and relating one or more incentives to one or more projection attributes, so that the one or more incentives are associable with the accounts; (B) an interaction facility that can access the account manager via closed and open modes, the closed modes involve one or more venue interfaces interactive in conjunction with transaction venues while the open modes involve one or more discretionary interfaces, so that an account holder can select one or more projections to associate with their account(s) via the accessing of the account manager; and (C) one or more provisioning facilities, linked with the first venue interface, that provides the account holder a compilation of one or more projections and related incentives from the holder's account.

The first system can further comprise one or more of (a) an incentive identifier that identifies one or more of the transaction incentives as related to projection attributes so that the identified related incentives are individually associable with accounts; (b) an account benefit comptroller, optionally integrated with the account administrator, that appraises incentive realization benefits and, optionally, aggregates one or more uncollected incentive realization benefits and, optionally, records the aggregated uncollected benefits; and (c) a transaction projection assessor, optionally integrated with the account administrator, that assesses projections that are applicable to a transaction opportunity.

The first system can further comprise or include one or more of: (a) the at least a first attribute involving a projection's applicability to one or more transaction opportunities; (b) the one or more incentives also being applicable to one or more transaction opportunities; (c) the one or more attributes involving proximity to applicable transaction opportunities; (d) the one or more attributes involving one or more patterns of one or more characteristics of the one or more account associated projections, patterns that include projection histories and projection concurrences; (e) the one or more attributes involving past or present realization statuses of one or more of the associated projections; (f) the attributes can include temporal and/or cost-related attributes; (g) the attributes can involve categorization aspects of the projections; (h) incentives can be configurable to institute the attribute relating; (i) the attributes relate to one or more of the account holder's projection compilations; (j) the attributes relate to providing the account holder's projection compilations; (k) the venue interfaces involve a fixed interface that optionally resides within a kiosk; (l) the venue interfaces involve touch screens; (m) the venue interfaces involve preset portable interfaces; (n) the discretionary interfaces provide access via account holder selected network accessing devices; (o) the discretionary interfaces are Internet accessible; (p) the discretionary interfaces are provided by one or more software applications residing on discrete devices for utilization by account holders to access the interaction facility; (q) the discretionary interfaces are provided by one or more software applications that reside on collectively accessible websites for utilization by account holders to access the interaction facility; (r) the discretionary interfaces are accessed in conjunction with web browsers; (s) the provisioning facilities provide representations of selected compilations of projections and related incentives; and (t) representations can have characteristics of a shopping list containing selected item procurement projections and one or more incentives related to one or more of the selected item procurement projections.

A first method of facilitating projected transactions comprising the steps of (A) managing accounts, transaction projections, and transaction incentives by associating projections with accounts, and relating incentives to attributes of projections, so that incentives can be associated with accounts; (B) accessing the managing by interacting with an interaction facility that is accessible via both closed and open modes, the closed modes involving venue interfaces interactive in conjunction with transaction venues, the open mode involving discretionary interfaces, the accessing enabling an account holder to select projections for associating with their accounts; and (C) providing account holders projection and related incentive compilations from their accounts via provisioning facilities linked with venue interfaces.

The first method can further comprise steps or include one or more of: providing one or more of (a) access to, (b) the functionality of, and (c) the utilization of the first method.

A first transaction projection facilitating product, produced according to the process of the first method, embodying at least one of the functionality, functional utilization, functional benefit, and operative action of the process of the first method.

A second system for facilitating projected transactions comprising: (A) an account administrator that manages accounts, transaction projections, and transaction incentives, including managing by associating projections with accounts; (B) an interaction facility that can access the account administrator via closed and open modes thereby enabling the account holders to select projections for associating with their accounts; (C) an incentive identifier that identifies one or more incentives that relate to projection attributes so that the identified related incentives are individually associable, optionally by the account administrator, with the accounts; (D) the account administrator compiling sets of account associated projections, the sets optionally also including account associable incentives.

The second system can further comprise one or more of (a) one or more provisioning facilities, linked with the first venue interface, that provide account holders with compilations of projections and related incentives from the holder's account; (b) an account benefit comptroller, optionally integrated with the account administrator, that appraises incentive realization benefits and, optionally, aggregates uncollected incentive realization benefits and, optionally, records the aggregated uncollected benefits; and (c) a transaction projection assessor, optionally integrated with the account administrator, that assesses projections applicable to one or more transaction opportunities.

The second system can further include account holders selecting projections for account associating by specifying projection parameters with, optionally, the account administrator implementing the associating according to one or more projection parameter featuring protocols; wherein the projection parameters can include, relate to, or involve one or more of (a) prior account associations, and/or (b) correlations with previous associated projections, and/or (c) associated projection patterns, and/or (d) proximity to transaction opportunities, and/or (e) projection parameter categorization aspects, and/or (f) temporal parameters, and/or (g) cost-related parameters, and/or (h) account holders' projection compilations, and/or (i) account holders' projection compilation provisionings.

Additionally, the second system can also further include the projection compiling involving an at least partial specification of one or more projection parameters, the account administrator optionally implementing the compiling according to one or more projection parameter featuring protocols; wherein these projection parameters can include, relate to, or involve one or more of (a) prior account compiling, and/or (b) correlations with previous compiled projections; and/or (c) compiled projection patterns; and/or (d) proximity to transaction opportunities; and/or (e) compiled projection categorization aspects; and/or (f) temporal parameters; and/or (g) cost-related parameters; and/or (h) account holders' projection compilations; and/or (i) account holders' projection compilation provisionings.

Moreover, the second system can still further include the incentive compiling involving an at least partial specification of one or more account associable incentive parameters, the account administrator optionally implementing the compiling according to one or more account associable incentive parameter featuring protocols; wherein the account associable incentive parameters can include, relate to, or involve one or more of (a) prior first account compiling of account associable incentives and/or secondary incentives that correlate with compiled incentives; and/or (b) compiled incentive patterns; and/or (c) proximity to transaction opportunities; and/or (d) categorization aspects of the account associated incentives; and/or (e) temporal parameters; and/or (f) cost-related parameters; and/or (g) an account holder's prior projection compilations; and/or (h) an account holder's prior projection compilation provisionings.

Furthermore, the second system can include as well the incentive identifying involving an at least partial specification of one or more potentially related incentive parameters, the account administrator optionally implementing the incentive identifying according to one or more potentially related incentive parameter featuring protocols; wherein the potentially related incentive parameters can include, relate to, or involve one or more of (a) prior identifying of potentially related incentives and/or previously identified secondary incentives that correlate with potentially related incentives; and/or (b) potentially related incentive patterns; and/or (c) proximity to transaction opportunities; and/or (d) categorization aspects of the potentially related incentives; and/or (e) temporal parameters; and/or (f) cost-related parameters; and/or (g) an account holder's prior projection and/or incentive identifying; and/or (h) an account holder's prior compiling and/or provisioning of projections and/or incentives.

Yet further, the second system can also include the incentive identifying involving or incorporating one or more of (a) incentive targeting, wherein one or more prescribed incentives are predirected to be related to projection attributes; and/or (b) incentive tailoring, wherein arranged incentives are directed to institute the relating in response to projection attributes.

In addition, the second system can yet further include the incentive identifying involving an at least partial specification of one or more identifiable incentive parameters, the account administrator optionally implementing the incentive identifying according to one or more identifiable incentive parameter featuring protocols; wherein the identifiable incentive parameters can include, relate to, or involve one or more of (a) prior identifying of identifiable incentives and/or previously identified secondary incentives that correlate with identifiable incentives; and/or (b) identifiable incentive patterns; and/or (c) proximity to transaction opportunities; and/or (d) categorization aspects of the identifiable incentive; and/or (e) temporal parameters; and/or (f) cost-related parameters; and/or (g) an account holder's prior projection and/or incentive identifying; and/or (h) an account holder's prior compiling and/or provisioning of projections and/or incentives.

A second method of facilitating projected transactions comprising the steps of: (A) managing accounts, transaction projections, and transaction incentives such as by associating projections with accounts; (B) accessing the managing via one or more of closed and open modes so that a holder of the first account can select projections for associating with their account(s); (C) identifying incentives that relate to projection attributes so that the related incentives are individually associable with accounts; and (D) compiling sets of account associated projections that optionally include account associable incentives.

The second method can further comprise steps or include one or more of: providing one or more of (a) access to, (b) the functionality of, and (c) the utilization of the second method.

A second transaction projection facilitating product, produced according to the process of the second method, embodying at least one of the functionality, functional utilization, functional benefit, and operative action of the process of the second method.

A third system for facilitating projected transactions comprising: (A) an account administrator that manages accounts, transaction projections, and transaction incentives, including managing by associating projections with accounts and, optionally, also by including one or more of either identifying incentives that relate to projection attributes and/or associating related incentives with accounts, and/or compiling sets of first account associated projections that may also include account associable incentives; and (B) an account benefit comptroller, possibly integrated with the account administrator, that appraises incentive realization benefits and, optionally, aggregates one or more uncollected incentive realization benefits and, optionally, records one or more uncollected benefits and/or the uncollected benefit aggregates.

The third system can further comprise one or more of (a) an interaction facility that can access the account administrator via closed and open modes, the closed modes operating in conjunction with transaction venues and involving at least one interactive venue interface, the open modes involving one or more discretionary interfaces, wherein the account administrator access enables account holders to select projections to associate with their accounts; (b) provisioning facilities, linked with the venue interfaces, that provide account holders compilations of projections and/or related incentives from their accounts; (c) an incentive identifier that identifies one or more transaction incentives as related to projection attributes so that the related incentives are individually associable with accounts; and (d) a transaction projection assessor, optionally integrated with the account administrator, that assesses projections that are applicable to a transaction opportunity.

Additionally, the third system can also include, relate to, or involve one or more of (a) the appraising involving one or more projection related valuation metrics, and/or involving one or more incentive characterizations; (b) the aggregating involving one or more facets of one or more accounts, and/or involving one or more incentive characterizations; (c) the recording involving one or more facets of one or more accounts, and/or involving one or more incentive characterizations.

A third method of facilitating projected transactions comprising the steps of (A) managing accounts, transaction projections, and transaction incentives, including managing by associating projections with accounts, and/or identifying incentives that relate to projection attributes and associating one or more related incentives with accounts, and/or compiling sets of account associated projections that also include account related associable incentives; and (B) appraising incentive realization benefits and, optionally, aggregating one or more uncollected incentive realization benefits and/or recording one or more of the benefit aggregates.

The third method can further comprise steps or include one or more of: providing one or more of (a) access to, (b) the functionality of, and (c) the utilization of the third method.

A third transaction projection facilitating product, produced according to the process of the third method, embodying at least one of the functionality, functional utilization, functional benefit, and operative action of the process of the third method.

A fourth system for facilitating projected transactions comprising: (A) an account administrator that manages accounts, transaction projections, and transaction incentives, including managing by associating projections with accounts, and by identifying incentives that relate to projection attributes and associating related incentives with accounts, and by compiling one or more sets of account associated projections that may further include one or more account related associable incentives; and (B) a transaction projection assessor, possibly integrated with the account administrator, that assesses one or more of the projections and incentives that are applicable to one or more transaction opportunities.

The fourth system can further comprise one or more of: (a) an interaction facility that can access the account administrator via closed and open modes, the closed modes operating in conjunction with transaction venues and involving at least one interactive venue interface, the open modes involving one or more discretionary interfaces, wherein the account administrator access enables account holders to select projections to associate with their accounts; (b) provisioning facilities, linked with the venue interfaces, that provide account holders compilations of projections and/or related incentives from their accounts; (c) an incentive identifier that identifies one or more transaction incentives as related to projection attributes so that the related incentives are individually associable with accounts; and (d) an account benefit comptroller, possibly integrated with the account administrator, that appraises incentive realization benefits and may also aggregate one or more uncollected incentive realization benefits and may further also record one or more of the uncollected benefit aggregates.

Additionally, the fourth system can also include, relate to, or involve one or more of (a) the transaction projection assessor assessing one or more of the projections and/or incentives that are applicable to one or more transaction occurrences; and/or (b) the transaction projection assessor assessing one or more applicable transaction projections unrealized by one or more transaction opportunities; and/or (c) the transaction projection assessor assessing one or more applicable transaction projections unrealized by one or more transaction occurrences; and/or (d) the transaction projection assessor assessing one or more applicable transaction incentives unrealized by one or more transaction opportunities; and/or (e) the transaction projection assessor assessing one or more applicable transaction incentives unrealized by one or more transaction occurrences; and/or (f) the assessing involving passively sourced projection or incentive related information; and/or (g) the assessing involving actively sourced projection or incentive related information.

A fourth method of facilitating projected transactions comprising the steps of: (A) managing accounts, transaction projections, and transaction incentives, including managing by associating projections with accounts, and identifying incentives that relate to projection attributes and possibly associating one or more related incentives with accounts, and compiling sets of account associated projections that may also include account related associable incentives; and (B) assessing one or more projections that are applicable to one or more transaction opportunities.

Additionally, the fourth method can also include, relate to, or involve one or more of (a) the assessing involving transaction projections unrealized by potentially applicable transaction occurrences; and/or (b) the assessing involving transaction incentives unrealized by potentially applicable transaction occurrences; and/or (c) the assessing involving actively sourced projection related information; and/or (d) the assessing involving passively sourced projection related information.

The fourth method can further comprise steps or include one or more of: providing one or more of (a) access to, (b) the functionality of, and (c) the utilization of the fourth method.

A fourth transaction projection facilitating product, produced according to the process of the fourth method, embodying at least one of the functionality, functional utilization, functional benefit, and operative action of the process of the fourth method.

A fifth system for facilitating projected transactions comprising: (A) an account administrator that associates transaction projections with accounts, wherein attributes of associated projections can relate to transaction incentives so that the related incentives are associable with the projection associated accounts by the account administrator; (B) an interaction facility that can access the account administrator via closed and open modes, wherein the closed modes involve interactive venue interfaces operating in conjunction with transaction venues and the open modes involve discretionary interfaces, such that an account holder can select projections to associate with their account by accessing the account administrator; (C) a provisioning facility, linkable with the first venue interface, that can supply compilations of projections and related incentives from the holder's account; (D) an incentive identifier that identifies projection related transaction incentives so that the associated projections and projection related incentives are individually compilable and includable in one or more sets by the account administrator; (E) an account benefit comptroller, possibly integrated with the account administrator, that assesses uncollected incentive realization benefits and, optionally, aggregates uncollected benefits and, optionally, records the aggregated benefits; and (F) a transaction projection assessor, optionally integrated with the account administrator, that assesses projections which are applicable to transactions that have occurred.

Additionally, the fifth system can further comprise variability options that can include options of excludability and/or inoperability of (a) the interaction facility's closed mode, and/or the interaction facility's open mode, and/or the entire interaction facility; and/or (b) the incentive identifier; and/or (c) the provisioning facility; and/or (d) the account benefit comptroller; and/or (e) the transaction projection assessor.

A fifth method of facilitating projected transactions comprising: (A) associating transaction projections with accounts, and relating transaction incentives to associated projection attributes, such that projection related incentives are associable with projection associated accounts; (B) accessing accounts and/or associated projections and/or associated incentives via closed and/or open interaction facility modes, wherein open accessing modes can involve discretionary interfaces and closed accessing mode can involve venue interfaces interactive in conjunction with transaction venues, such that the accessing modes enable account holders to select projections to associate with their accounts; (C) supplying account holders compilations of projections and incentives from their accounts via provisioning facilities linkable with interaction facilities; (D) identifying projection related transaction incentives so that the projection related incentives are individually compilable with associated projections in one or more sets; (E) appraising uncollected incentive realization benefits and, optionally, aggregating uncollected benefits and, optionally, recording the aggregated benefits; and (F) assessing transaction opportunity applicable projections and, optionally, transaction opportunity applicable incentives.

Additionally, the fifth method can further comprise variability options that can include options of excludability and/or inoperability of (a) the interaction facility's closed mode, and/or the interaction facility's open mode, and/or the entire interaction facility; and/or (b) the provisioning facility; and/or (c) the identifying of projection related transaction incentives; and/or (d) the appraising of uncollected incentive realization benefits; and/or (e) the assessing of the transaction applicable projections.

The fifth method can further comprise steps or include one or more of: providing one or more of (a) access to, (b) the functionality of, and (c) the utilization of the fifth method.

A fifth transaction projection facilitating product, produced according to the process of the fifth method, embodying at least one of the functionality, functional utilization, functional benefit, and operative action of the process of the fifth method.

A sixth method of facilitating projected transactions comprising: realizing a first process that includes sub-step (A) and two or more of sub-steps (B) through (H), wherein at least a part of one or more of the sub-steps (A) through (H) being optionally supplantable, the sub-steps (A) through (H) consisting of,
(A) associating transaction projections with accounts, and relating transaction incentives to associated projections' attributes so that the related incentives can also be account associated; (B) accessing accounts and/or their associated projections or incentives, via closed and/or open interaction facility modes, wherein open accessing modes can involve discretionary interfaces and closed accessing modes can involve venue interfaces interactive in conjunction with transaction venues, so that the accessing enables account holders to select projections for associating with their accounts; (C) supplying account holders with compilations of projections and/or related incentives from their accounts via a provisioning facility linkable with the interaction facility; (D) identifying projection related transaction incentives so that account associated projections and projection related incentives are individually compilable for inclusion in sets; (E) assessing projections applicable to transaction occurrences; (F) appraising uncollected incentive realization benefits; (G) aggregating uncollected incentive realization benefits; (H) recording uncollected incentive realization benefit aggregates;
   wherein, the supplanting optionality involves communicating surrogate information that substitutes for occurrence of the supplanted parts of sub-steps (A) through (H).

The sixth method for facilitating projected transactions can further comprise realization of the supplanting optionality by communicating the surrogate information, and may as well include the supplanting involving engendering the substitutability, wherein the engendering comprises one or more of preparing the surrogate information, sending the surrogate information, receiving the surrogate information, processing the surrogate information, responding to the surrogate information as an analogue to the supplanted occurrence, providing access to or accepting provision of the surrogate information, and treating the surrogate information as a substitute for the supplanted occurrence.

Additionally, the sixth method can also comprise the step of providing the functionality of utilization of the supplanted optionality.

A sixth transaction projection facilitating product, produced according to the process of the sixth method, embodying at least one of the functionality, functional utilization, functional benefit, and operative action of the process of the sixth method.

A seventh transaction projection facilitating product-by-process consisting of the functionality of a seventh process of facilitating transaction projections that comprises a first step of associating transaction projections with accounts and relating transaction incentives to attributes of the associated projections, so that the projection related incentives are associated with the accounts; and further comprises one or more further steps of:
(A) accessing the accounts and/or the associated projections or incentives via closed and/or open interaction facility modes, wherein open accessing modes involve discretionary interfaces and closed accessing modes involve venue interfaces interactive in conjunction with transaction venues, with the accessing enabling an account holder to select projections to be associated with their account;
(B) supplying the account holder projection and/or related incentive compilations from their account with provisioning facilities linkable with the interaction facility;
(C) identifying projection related transaction incentives so that the associated projections and/or the projection related incentives are individually compilable for optional inclusion in one or more sets;
(D) appraising uncollected incentive realization benefits and, optionally, aggregating the uncollected benefits and, optionally, recording the benefit aggregates; and
(E) assessing transaction projections applicable to one or more transaction opportunities.
   It should also be understood that it falls within the scope of the present invention for the vast majority of the differing additional further, and/or alternative options and capabilities outlined in the paragraphs [0014] through [0054] are also combinable in various numbers, assortments, and permutations so that options that are described in relation to one of the systems and/or methods of the present invention are also combinable with the other systems and methods of the present invention, outside of those combinations which are directly contradicted by the core system and/or method that is being combined with.

The terms and phrases in the present application, and in particular in the claims, are normally to be construed in “accordance” with their ordinary interpretations. However, while this general approach is not intended to be contraindicated by the following, there are certain terms and phrases for which the extensive breadth of connotations intended herein are likely better understood by noting the following considerations listed by term or phrase accompanied by detailed germane noteworthy considerations:
a) “account administrator”—can include wide ranging manners of majority or partial realization of account administration, including partial or full implementations as single and/or multiple software programs, centralization in consolidated facilities and/or distribution among a plurality of facilities, as well as decentralization in various manners including peer-to-peer networks and/or separate locally resident applications that may even, though not necessarily, only communicate via networks.
b) “manages”—can include wide ranges of manners of majority or partial realization of managing effects, including both direct and indirect effects, differing degrees of active or passive managing, partial or full implementation via a single or multiple software programs and may, though not necessarily, involve differing degrees of automatic, autonomous, rule or algorithm based, and conditional or selective operations.
c) “transaction projections”—is a phrase whose breadth of applicability is rooted in the expansive scopes of the meanings of its constituent terms. The term “transaction” can include, though it does not necessarily entail, essentially any form of interchange, while the term projection can include anything that is in the condition of being projected, such as a plan, a design, or a shopping list.
d) “transaction incentives”—is a phrase that includes the scope of the term “transaction” in combination with the application of anything that can or tend to incite that transaction.
e) “at least a first attribute”—is a phrase that is of significance herein due to the import of the term “attribute” which applies to essentially anything, any manner of description, or any quality of, or potentially of, a projection.
f) “interaction facility”—can include wide ranging manners of majority or partial realization of functioning as a facilitator of interaction with the account administrator, including partial or full implementations as single and/or multiple software programs, centralization in consolidated facilities and/or distribution among a plurality of facilities, as well as decentralization in various manners including peer-to-peer networks and/or separate locally resident applications that may even, though not necessarily, only communicate via networks.
g) “closed mode”—includes, though does not necessarily entail, that the generally understood interpretation of the phrase “closed” applies to the relevant access modes in that these modes are at least partially pre- or pro-scribed, and are at least somewhat excluded from influence or alteration from outside (meaning outside of embodiments of the system, method, or product).
h) “open mode”—includes, though does not necessarily entail, that the generally understood interpretation of the phrase “open” applies to the relevant access modes in that these modes are at least partially unrestricted, and are at least somewhat available for influence or alteration from outside (meaning outside of embodiments of the system, method, or product).
i) “venue interface”—includes interfaces that function in at least partial association with venues, wherein “venue” refers to, but is not limited by, a scene or local of any action or event and can, of course, encompass virtual, physical, situational, temporally related, and hybrid environments.
j) “discretionary interface”—can include interfaces that are utilizable by account holders, among others, to interact with the interaction facility. The interfaces used, such as personal computers or smartphones as well as various virtual environments that can reside on such an information processing device, are at least partially selected according to the user's discretion.
k) “provisioning facility”—can include essentially any facility that can provide compilations, and can encompass virtual, physical, situational, temporally related, and hybrid facilities, such as a printer at a store kiosk, a data compilation that is displayable on a cellphone, or a tablet display affixed to a shopping cart.
l) “incentive identifier”—can include essentially any resource able to effect data mining, characteristic analysis or matching, or the like, and can encompass virtual, physical, situational, temporally related, and hybrid identifier realizations.
m) “account benefit comptroller”—can include essentially any resource able to effect control, management, supervision, monitoring, and/or accounting of account benefits, and can encompass virtual, physical, situational, temporally related, and hybrid comptroller realizations.
n) “incentive realization benefits”—can include essentially any benefit associated with realization of an incentive benefit.
o) “uncollected incentive realization benefits”—can include those incentive realization benefits that are at least partially in some fashion not gathered or distributed upon realization of the incentive benefit.
p) “transaction projection assessor”—can include essentially any resource capable of assessing projections. The assessing can encompass calculating a value based on various factors, in addition to, though not limited to, examining in order to judge or evaluate in a manner that may be at least partially unconnected to valuation; and can encompass virtual, physical, situational, temporally related, and hybrid assessor realizations.
q) “transaction opportunity”—can include essentially any option or occasion for the potential occurrence of a transaction.
r) “projection applicable transaction opportunity”—can include essentially any transaction opportunity that a projection could be applied to, including those opportunities to which, even though the projection is not fully realized, the at least partially unrealized projection would be applicable if the projection were fully realized. It should be further noted that a projection's applicability, or its potential applicability, is also an attribute of that projection.
s) “proximity”—can include not only the most familiar connotations of the term, such as spatial or temporal closeness, but can also include nearness factors that are non-physical conditions such as the next item in a serial list of projected procurements, and/or habitual projection patterns wherein when an individual account holder projects a specific set of procurements that account holder also tends to project a specific other procurement within their next three successive projection compilations, and/or a provider appointment (e.g. a massage appointment) that is a regular consequence of a projection pattern (e.g. a recommended list of supplies to buy for a 100 mile charity bike ride), and/or ingredients needed for a recipe for a dessert that is a frequent accompaniment of items already projected to be procured on a given shopping trip.
t) “realization statuses”—can include various traits of projections, incentives, incentive benefits, incentive benefit collection states, incentive benefit aggregations, incentive benefit recordations, projection and/or incentive compilations, that are relevant to or influencing of the circumstances of their being realized.
u) “cost”—can include not just not the ordinary connotation of a price paid, but can also include essentially any quality that is characterizable as a cost such as opportunity costs, time expenditures, or concomitant expenses due to a lack of procurement.
v) “categorization aspect”—can include essentially any factor, characteristic, or quality that at least partially provides, relates to, influences, or is involvable in any form of categorization that relates to that aspect.
w) “fixed interface”—can include interfaces that are fixed in that they are at least partially predetermined, present options that are available with some limitations, and/or have some constraints on there flexibility; while the nature of the qualities that can be subject to these sorts of ‘fixing’ can include physical characteristics and/or dispositions, and/or modalities (such as visual, audio, Bluetooth, etc.) by which the interface is interacted with, and/or software programs or databases that the fixed interface can access, and/or contents that are presented via the fixed interface.
x) “predetermined portable interface”—can include interfaces that incorporate at least a degree of physical disposition flexibility, such as a shopping cart with an integrated touchscreen, but that also incorporate at least some of the fixing features of the fixed interface.
y) “network”—can include essentially any form of an interconnected information handling system, such as telephone or cellphone networks, the world wide web, corporate or school intranets, and/or groups of socially linked entities, e.g. twitter followers or facebook fans.
z) “discrete devices”—can include devices that are distinct and/or separate from other devices, though they may also be network accessing, when so desired.
aa) “collectively accessible websites”—refer to websites that a collection of entities (e.g. persons or software purchasing agents) can all access, as opposed to, for example, websites that are available to limited numbers, such as those restricted to membership clubs.
bb) “representation”—can include visual or auditory depictions, machine readable data that is translatable into a representation, physical printouts, impermanent expressions of the representations (e.g. a cell phone screen image,) and other communications that can provide the equivalent of a physical representation.
cc) “secondary projections”—can include projections that are not the first or primary projections, but are sufficiently correlated with a first or primary projection (that has generally been selected by an account holder) to warrant possible association in concert with the first y
dd) “potentially related incentives”—can include those incentives that have possibilities of being related to, for example, a projection, and hence at least some of the properties of the incentive are at least partially recognized so that the potential relating can occur.
ee) “identifiable incentives”—can include essentially incentive that is potentially available for identifying.
ff) “actively sourced”—can include information that is sourced by or in combination with activities specifically effected to garner the information, such as surveys and/or review questionnaires.
gg) “passively sourced”—can include information that is not sourced by or in combination with activities specifically effected to garner the information, such as surveys and/or review questionnaires, but rather by collecting and/or analyzing information without the active participation of the account holders, such as comparing differences in projection realization rates for one form of incentive vs. another form of incentive.

Other objects and features will be in part apparent and in part pointed out hereinafter.

### BRIEF DESCRIPTION OF THE DRAWINGS

FIG. 1 is a schematic view of a typical arrangement of various hardware components and communication channels for executing certain embodiments of the present invention.

FIG. 2 is a Site Map depiction of assorted interfaces that are accessible from a web-based Home Page interface of a first retail consumer user embodiment of the present invention.

FIG. 3 is a flow chart depiction of actions available from the Login interface of the first retail consumer user embodiment of the present invention.

FIG. 4 is a flow chart depiction of a User Registration interface accessible from the Login interface of the first retail consumer user embodiment of the present invention.

FIG. 5 is a flow chart depiction of assorted interfaces that are accessible from the Dashboard interface of the first retail consumer user embodiment of the present invention.

FIG. 6 is a flow chart depiction of assorted Dashboard interfaces that are accessible from the My Shopping List interface of the first retail consumer user embodiment of the present invention.

FIG. 7 is a flow chart depiction of the process of populating a shopping list on the Shopping List dashboard of the first retail consumer user embodiment of the present invention.

FIG. 8 is a flow chart depiction of a shopping list incentive selection process of the first retail consumer user embodiment of the present invention.

FIG. 9 is a flow chart depiction of a typical order of interactions with a first kiosk interface of the first retail consumer user embodiment of the present invention.

FIGS. 10a and 10b are a divided schematic chart of typical relationships between database tables utilized for organizing and providing information in the first retail consumer user embodiment of the present invention.

FIG. 11 is a representation of a web-based page My Shopping Lists interface according to the first retail consumer user embodiment of the present invention.

FIG. 12 is a representation of a web-based page Home interface according to the first retail consumer user embodiment of the present invention.

FIG. 13 is a representation of a web-based page Home interface according to the first retail consumer user embodiment of the present invention.

FIG. 14 is a representation of a web-based page Home interface according to the first retail consumer user embodiment of the present invention.

FIG. 15 is a representation of a web-based page Home interface according to the first retail consumer user embodiment of the present invention.

FIG. 16 is a representation of a web-based page Home interface according to the first retail consumer user embodiment of the present invention.

FIG. 17 is a representation of a web-based page Home interface according to the first retail consumer user embodiment of the present invention.

FIG. 18 is a depiction of a kiosk welcome screen of at least the first retail consumer user embodiment of the present invention.

FIG. 19 is a representation of an Email entry interface of at least the first retail consumer user embodiment of the present invention.

FIG. 20 is a representation of a kiosk user sign-in interface of at least the first retail consumer user embodiment of the present invention.

FIG. 21 is a representation of a kiosk dashboard interface of at least the first retail consumer user embodiment of the present invention.

FIG. 22 is a representation of first popup enquiry interface of at least the first retail consumer user embodiment of the present invention.

FIG. 23 is a representation of a second popup enquiry interface of at least the first retail consumer user embodiment of the present invention.

FIG. 24 is a representation of a first popup error message interface of at least the first retail consumer user embodiment of the present invention.

FIG. 25 is a representation of a second popup error message interface of at least the first retail consumer user embodiment of the present invention.

FIG. 26 is a representation of a List Review & Editing interface of at least the first retail consumer user embodiment of the present invention.

FIG. 27 is a representation of a third informational popup interface of at least the first retail consumer user embodiment of the present invention.

FIG. 28 is a representation of a Coupon Selection interface of at least the first retail consumer user embodiment of the present invention.

FIG. 29 is a representation of a printing progress screen of at least the first retail consumer user embodiment of the present invention.

FIG. 30 is a representation of an Issue Report interface of at least the first retail consumer user embodiment of the present invention.

### DETAILED DESCRIPTION OF THE PREFERRED EMBODIMENTS

In the following description, identical numbers indicate identical elements. Where an element has been described in one Figure, and is unaltered in detail or relation in any other Figure, said element description applies to all Figures.

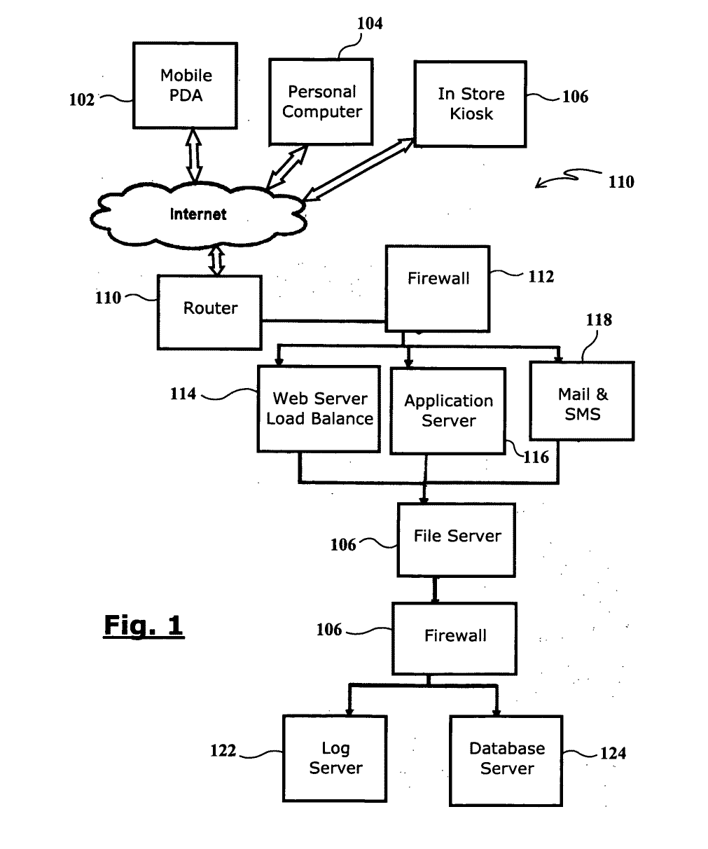

FIG. 1 depicts a representative schematic arrangement of hardware and communication channels 110 utilizable for implementing the first retail consumer user embodiment of the present invention. Consumers generally will interact with the first retail consumer user embodiment of the present invention via multiple interface modes, including a mobile device 102, a computer 104, and/or a kiosk 106. Consumer Internet communications 108, after passing a router 110 and a firewall 112, are processed by at least one of web servers 114, application servers 116, as well as e-mail and SMS servers 118. The application server also interacts with a file server 120, which further interacts, through another firewall 112, with a log server 122 and a database server 124.

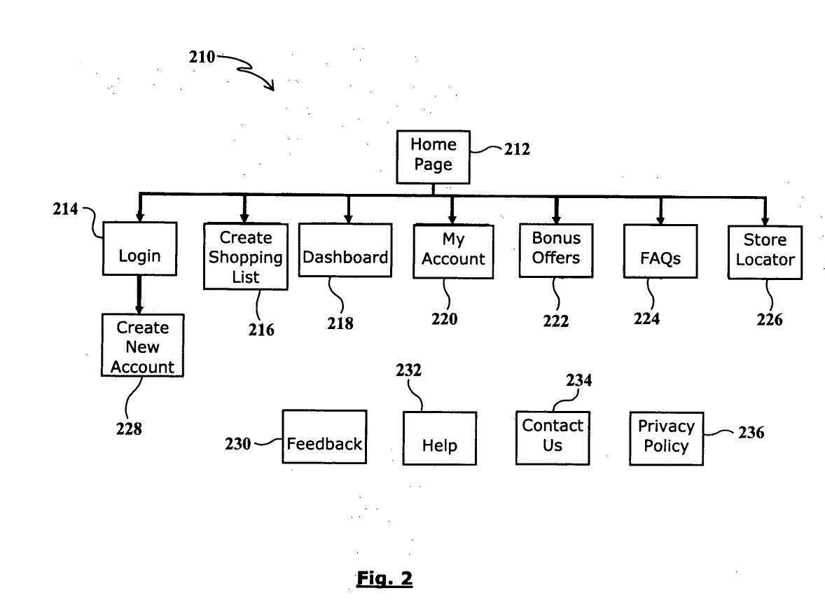

As shown in FIG. 2, the Site Map 210 shows a variety of secondary interfaces that are accessible from a Home Page 212 interface such as are accessible via a web home page interface of the first retail consumer user embodiment of the present invention. These secondary interfaces include a Login interface 214, a Create Shopping List 216 interface, a Dashboard 218 interface, a My Account 220 interface, a Bonus Offers 222 interface, a Frequently Asked Questions 224 interface, and a Store Locator 226 interface. A sub-secondary Create New Account 228 interface is further accessible from the Login 214 interface for new users to register with the first retail consumer user embodiment of the present invention. Further interfaces that may be partially or wholly available when accessing at least some of the Home Page 212 interface, as well as the secondary interfaces, include a Feedback 230 button that provides means for providing information back to the first retail consumer user embodiment of the present invention; a Help 232 button; a Contact Us 234 button, and a Privacy Policy 236 button, all of which are analogous to standard web site buttons and functions as are well known to a major portion of the U.S. population.

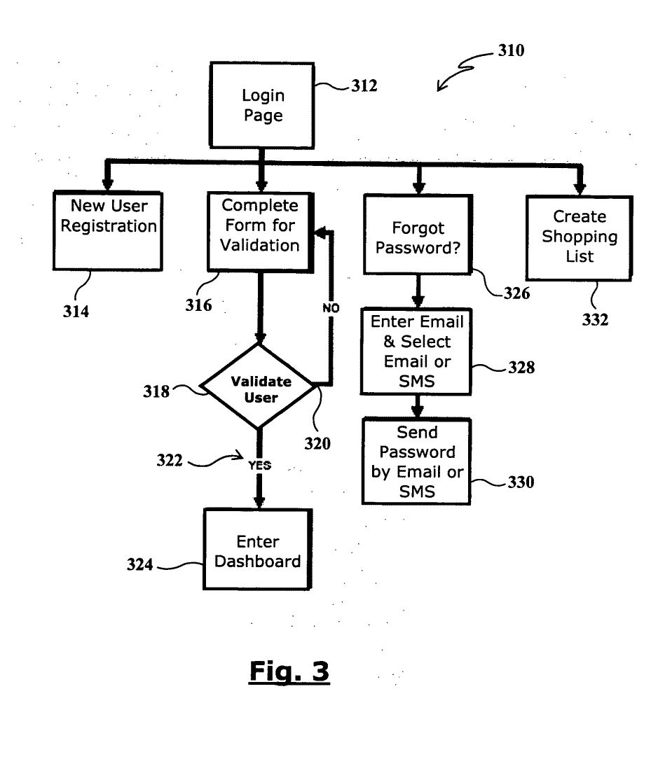

Seen in FIG. 3 is the flow chart of user login 310 actions with the Login page 312. If not yet registered, a consumer can access New User Registration 314. If already registered, the member can execute a Complete Form for Validation 316 that then attempts to validate 318 that the user is a member. If the validate user stage is unsuccessful, the member is then returned 320 back to Complete Form for Validation 316. If the user is validated 322 as a member, the member can then access the Dashboard 324. Alternatively, when a member needs to retrieve their password, they access a Forget Password 326 interface, wherein they then enter their registered e-mail address 328 and select whether to receive their password via e-mail or SMS message, which is then sent 330. Further alternatively, a member can access a Create Shopping List 332 function.

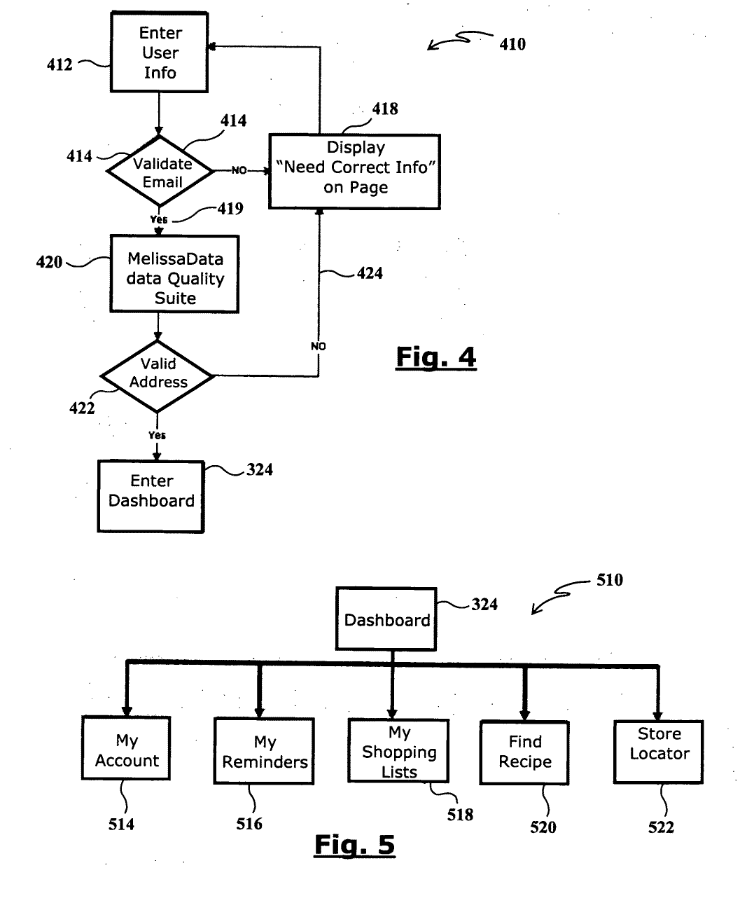

The User Registration 410 flowchart shown in FIG. 4 initiates with the entry of registration information 412 which is then sent for validation 414 of the e-mail address. If the e-mail address is not validated 416, the user then encounters an Information Correction page 418 and is then returned to the entry of registration information 412. If the e-mail address is validated 419, the registration information is then passed to a MelissaData tool 420 to verify 422 the user address entered. If the address is not validated 424, the user is then sent to the Information Correction page 418. If the address is also validated, the user is then sent to the Dashboard 324.

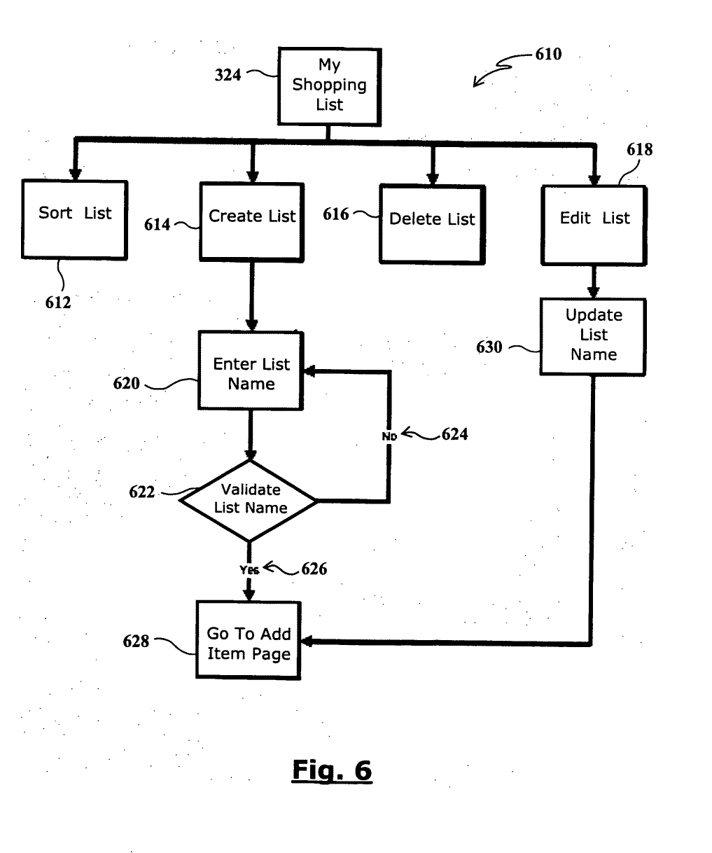

FIG. 5 shows a Dashboard map 510 that includes variety of optional functionalities available from the Dashboard 324 of the first retail consumer user embodiment of the present invention. These optional dashboard functionalities include a My Account 514 module, a My Reminders 516 module, a My Shopping Lists 518 module, a Find Recipe 520 module, and a Store Locator 522 module.

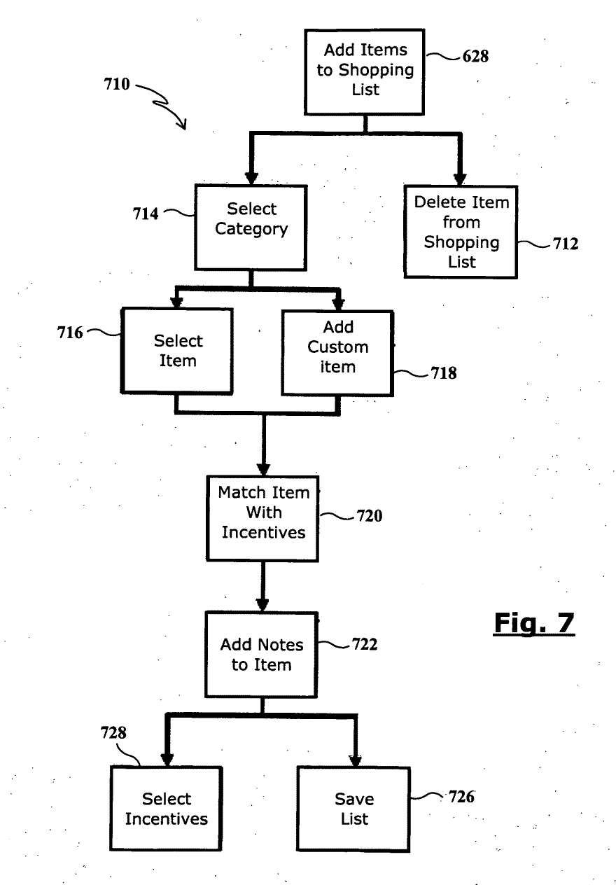

FIG. 6 schematically illustrates a My Shopping Lists module user interactions flow chart 610. At a first stage, available alternative options include Sort List 612, Create List 614, Delete List 616, and Edit List 618. From the Create List stage 614, a user first enters a name 620 for the new list, the name for the list is validated 622. When the list is not validated 624, the user is sent back to the enter name 620 stage. If the list name is validated 626 the user then proceeds to an Add Item 628 stage. From the Edit List stage 618, the user can alter existing lists and Update the List's Name 630 after which the user then accesses the Add Item stage 628.

An Add Items flow chart 710, stemming from the Add Items 628 stage, is shown in FIG. 7. From the Add Items 628 stage the user can delete items from an existing list 712, or can Select Category 714 of items for populating the shopping list under construction. Once a category has been selected, the user can select 716 a pre-categorized item within that category, or they can add a Custom Item 718 that is not yet in the pre-arranged category. Following selection of items for the list, the Items are Matched 720 with incentives, and notes may be added 722. The user then has at least two options, including Select Incentives 728 and Save List 726.

A Select Items flow chart 810, stemming from the Select Incentives 728 stage, is shown in FIG. 8. From the Select Incentives 728 stage, the user Selects a Category 812 of items, then Selects an Item 814 from the selected category, and Selects Incentives 816. If preferred, the user can then opt to either return to Select Category 812, or continue to Print Shopping List 820.

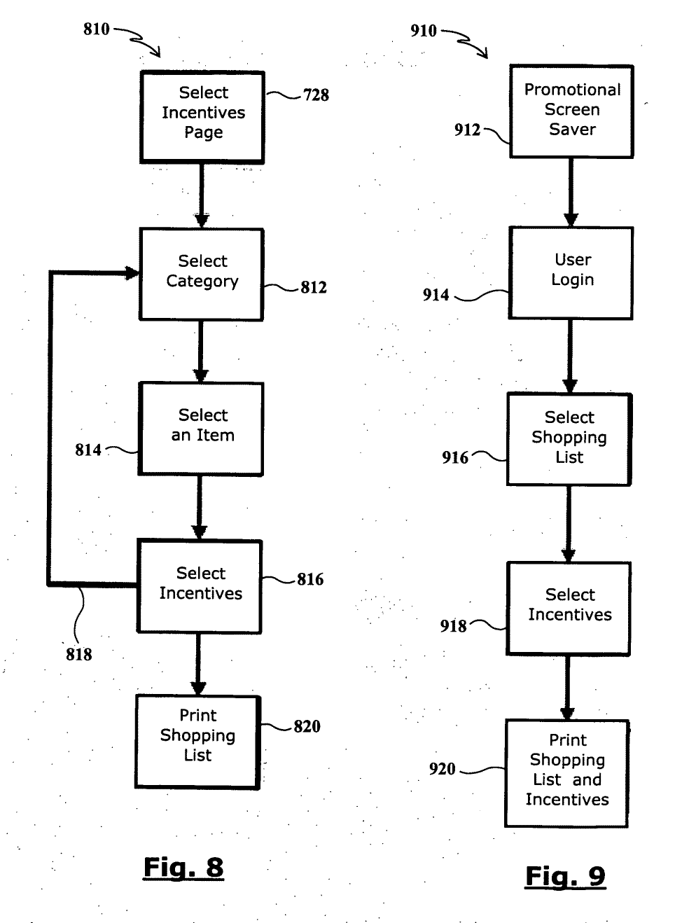

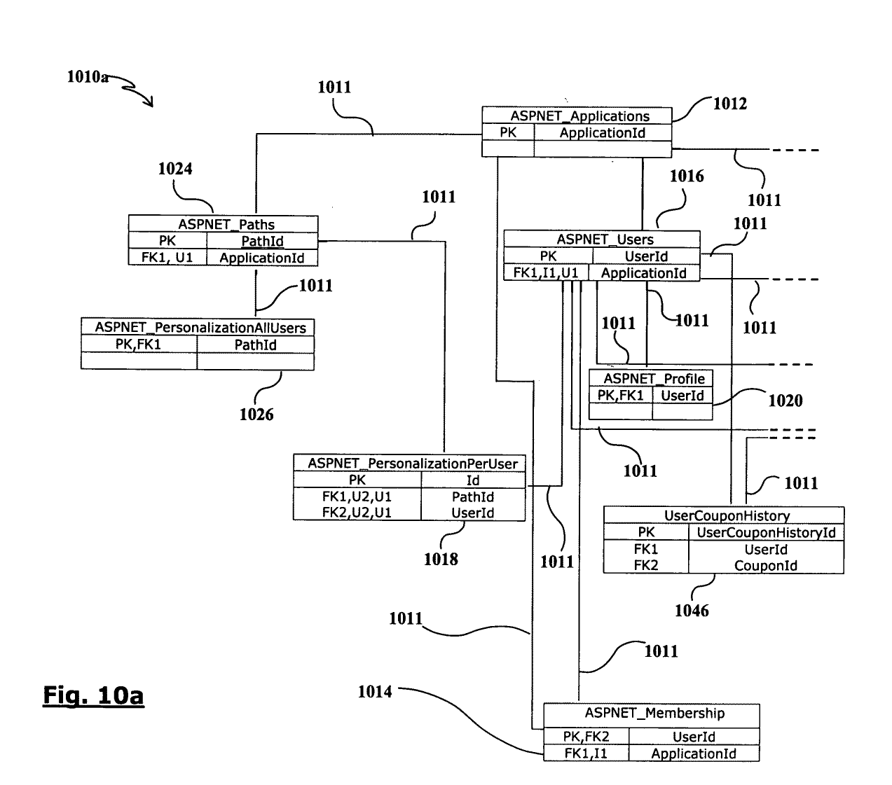

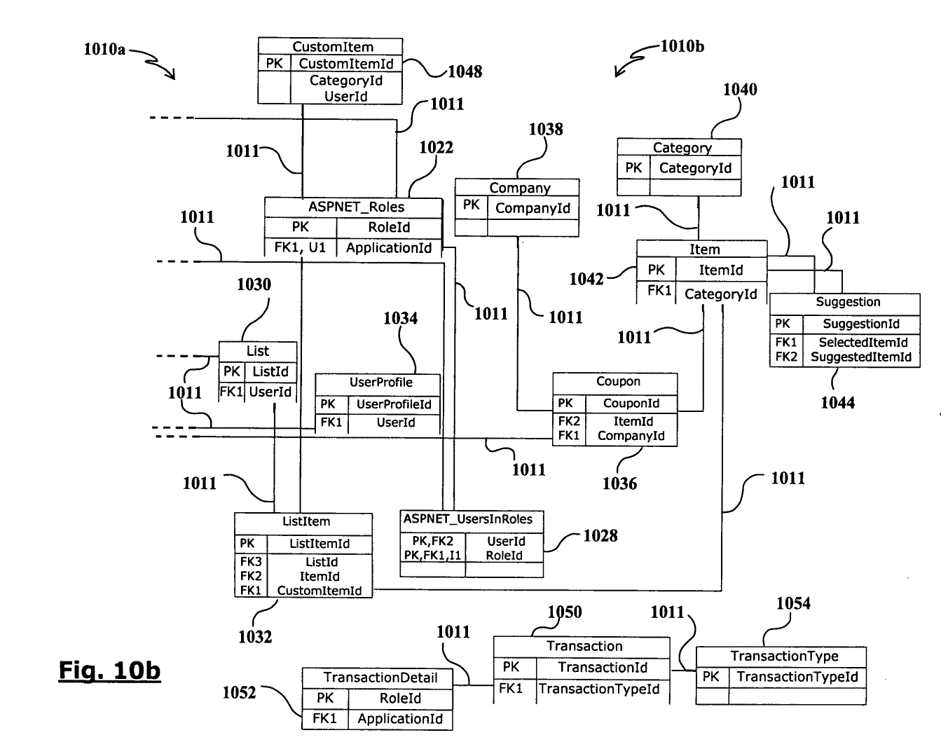

FIG. 9 shows a flowchart of Kiosk operations 910, which generally shows a promotional screen saver 912. When a user accesses the Kiosk 106, they are first prompted to Login 714. After successfully logging in, the user is then prompted to Select Shopping List 916, and then Select Incentives 918, followed by a prompt to Print Shopping List and Incentives 920.

Schematic organizational charts 1010a and 1010b illustrate a representation of database tables such as are utilized in the operation of the first retail consumer user embodiment of the present invention. The information in the various tables are shown along with the relations between information in their table and the related tables, with single head arrows indicating limited amounts of relations, and double headed arrows indicating larger amounts of relations between data within the respective tables. The definitions of the tables, their associated date types, and how to develop applications that utilize them are well known and can be understood from many publicly available references such as the text titled: “Application Architecture for .NET: Designing Applications and Services,” © 2002 Microsoft Corporation, version 1.0, which is incorporated herein by reference. EasySave implements ASP.NET Provider Model for membership, role management, role based security, and application state. Utilizing these providers will allow uniform interfaces between the applications services and the EasySave SQL database as well as provide a security platform that is flexible and extensible. Providers used by the EasySave application include:
a) Membership
b) Role management
c) Site map
d) Profile
e) Session state
f) Web events
g) Web Parts personalization
h) Protected configuration
   Included among the data tables (as numbered in FIG. 10) required by these providers are:
1. ASPNET_Application Table 1012: Stores the application data required for membership.
2. ASPNET_Membership Table 1014: Manages storage of membership information for an instance of an application.
3. ASPNET_User Table 1016: Used to store and retrieve User information.
4. ASPNET_Personalizationperuser Table 1018: Provides persistent storage of personalization states (state regarding the content and layout of Web Parts pages) for Web Parts.
5. ASPNET_Profile Table 1020: Stores profile data in Microsoft SQL Server.
6. ASPNET_Role Table 1022: Stores Role data that allows each user to be assigned a role.
7. ASPNET_Paths 1024: Each entry in the Paths table defines one path for which Web Parts personalization state has been saved.
8. ASPNET_PersonalizationAllUser 1026: Provides persistent storage of shared personalization states for Web Parts.
9. ASPNET_UsersInRoles 1028: Stores the data relating users to roles.
10. ASPNET_List Table 1030: Stores data associated with the shopping lists.
   While a descriptive list of the General Application Tables used by the EasySave application include:
11. ListItem Table 1032: Stores the relationship associating Items to a specific shopping list.
12. UserProfile Table 1034: Stores User Profile data such as mailing address and phone number.
13. Coupon Table 1036: Stores data related to coupons.
14. Company Table 1038: Stores data related to a company that issues the coupon.
15. Category Table 1040: Stores category data allowing items to be assigned to a specific category.
16. Item Table 1042: Stores data that defines items. These items will be available to all users system wide.
17. Suggestion Table 1044: Associates items with suggested items.
18. UserCouponHistory Table 1046: Stores data that tracks all coupons used by a user in the lifetime of the user account.
19. CustomItem Table 1048: Stores items that a user creates that are not currently available in the system wide Items.
20. Transaction Table 1050: Stores historical data that will track defined events captured through the usage of the site.
21. TransactionDetails Table 1052: Stores detailed information of events captured through the usage of the site.
22. TransactionType Table 1054: Denies the type of transaction to be tracked.
   A plurality of database table linkages 1011 illustrate the associations that exist among the datums in the various databases. In configuring the web application architecture, various well known and readily implemented software programs are utilizable, either separately or in combination. These include, at the presentation level: HTML, CSS, Java, JavaScript, DHTML, FLASH, AJAX, Applets, and Gadgets; at the application logic level: ASP, ASP.NET, CGI, ColdFusion, JSP/Java, PHP, Perl, Python, Ruby on Rails, and Struts2; and at the storage level: Microsoft SQL, Oracle, and MySQL. The uses and manners of arrangement of these software components are well known public knowledge, and are explained in references such as the aforementioned “Application Architecture for .NET: Designing Applications and Services,” ©2002 Microsoft Corporation, version 1.0.

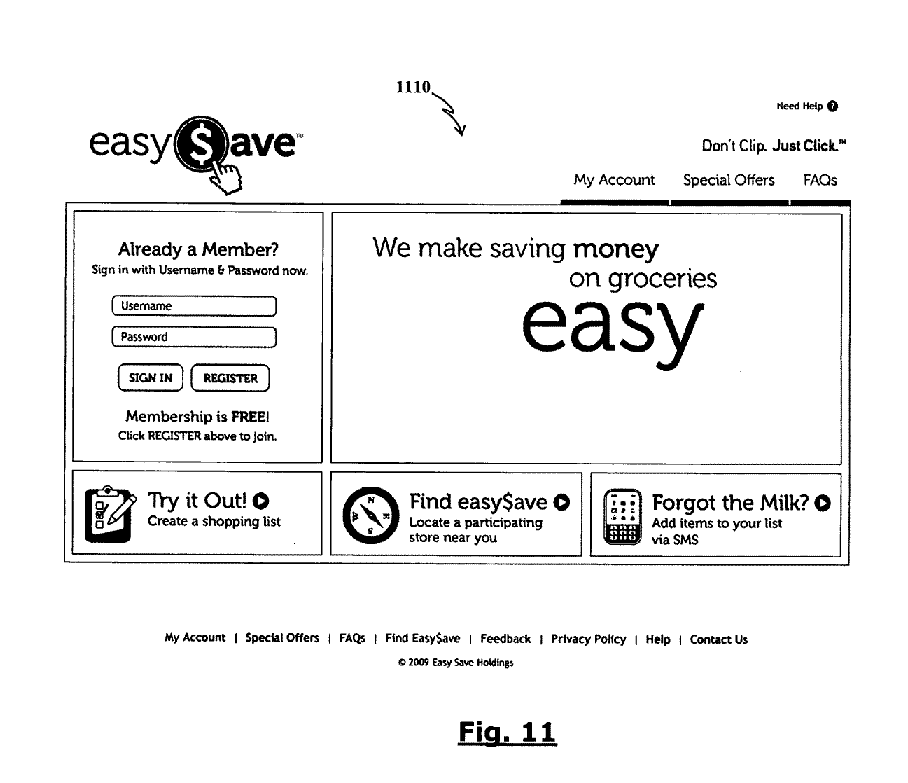

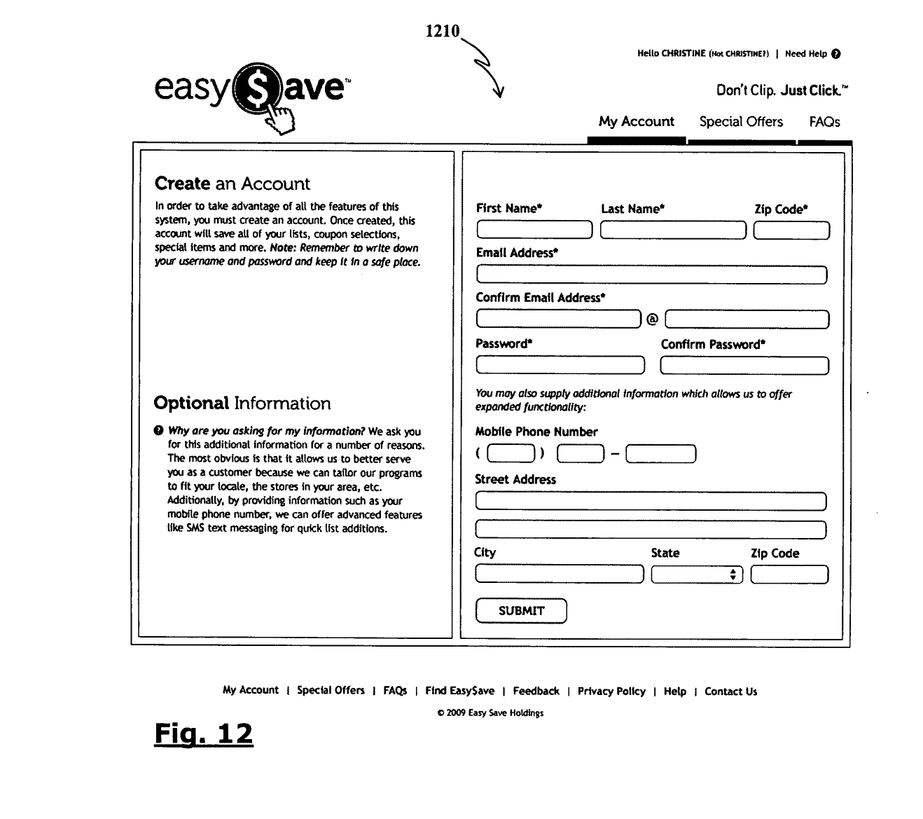

Upon first visiting the web based Home Page interface 212 a consumer will typically be shown a visual representation 1110 on the Home Page interface 212 as depicted in FIG. 11. The consumer may register for the first retail consumer user embodiment of the present invention, or take a trial run as a guest user.

When a consumer decides to become a registered member, a consumer will typically be shown a visual representation 1210 on the Home Page interface 212 as depicted in FIG. 11. a variety of information is usually collected including first and last name, e-mail address, and password. As a registered member, a consumer can, to enable additional functions, also decide to provide further information such as mobile phone number (primarily for SMS messaging,) and physical address information.

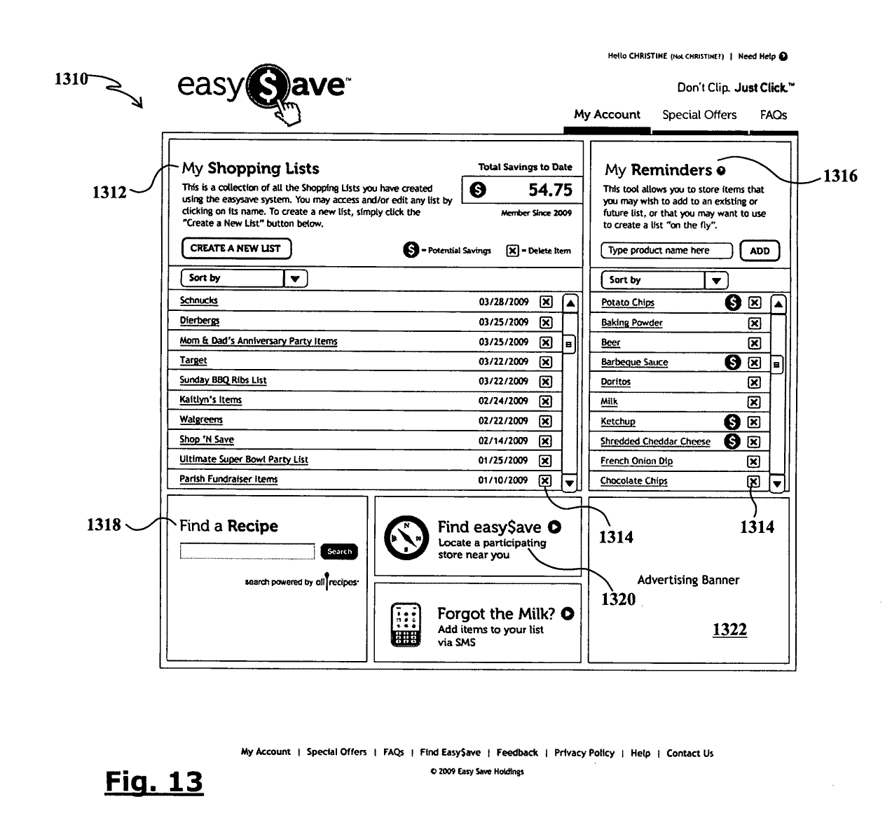

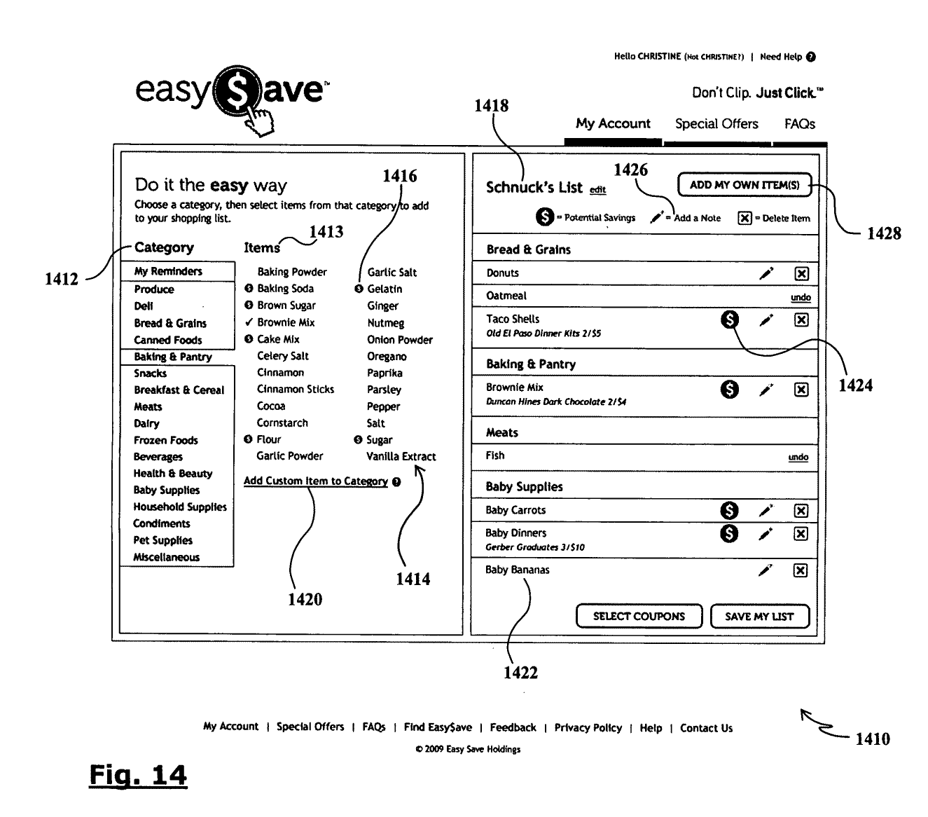

After registering, a consumer becomes an account holder and consumer will typically be shown a visual representation 1310 of the Dashboard 324 as depicted in FIG. 13. A member's dashboard presents a compilation of information relevant to their account. Among the features of the Dashboard 324 are:
a) Access to all saved lists created by the member. Among other manners, a member's lists 1312 can be organized by chronological order (date created), name, or date created. The member may also choose to delete lists from their saved list module by using a Delete Item control 1314.
b) A My Reminders control 1316 stores items added through SMS (text messaging) or email which are temporarily held in a My Reminders compilation. These items may be used to create a new list, or be added to existing lists. Items may also be deleted from this module using the Delete Item control 1314.
c) The Dashboard 324 also provides a Find a Recipe Module 1318. The Find a Recipe module 1318 can use one or more third parties' content to provide recipe-finding functionality to registered members.
d) A Find Participating Retailer Module 1320 allows users to locate a participating retailer that uses an embodiment of the present invention. This can be accomplished through a well known form of zip-code search module associated with a third party Map/Direction application (such as Google Maps.)
e) An Advertising Module 1322 on the Dashboard 324 also contains an area for third parties to buy advertising space on the Member Dashboard.

Upon selecting a list in the My Shopping Lists 518 module, or by choosing to create a new list, the Member will be taken to a list creation/editing representation 1410. From this representation, Members can use the left side functionality to select items from pre-defined categories. Among the notable aspects of the of the list creation/editing procedures are:
Categories of items from the My Reminders 516 module populate the initial positions on the category navigation/selection module 1412. The individual My Reminders Items 1413 appear within a yellow field 1414 that appears to the right of the category navigation/selection module 1412. Members may also choose to Select All Items with Potential Savings.
All items from main categories can appear to the right of the category menu, and can be visually associated with the selected category.
An item with an associated incentive appears with a green incentive icon 1416 next to its name.
Items selected for the list being created in the right side list field 1418 have a check-mark to the left of the item's name, and the item name in the list will be highlighted in green to denote it has been selected. Members may also choose to “Add Custom Item to Category” 1420 to add an item that does not appear in the standard categories.
   The right side list field 1418 allows for review and modification of the items selected for the list being created/edited. Notable of the list reviewing and editing module 1422:
Items with potential savings are noted by a large savings icon 1424;
Members may add a note 1426 to any item on their list. This note is saved and printed out when the Member retrieves their list(s) from the provider vicinity kiosk.
Items on the list may be deleted by selecting the Delete Item control 1314. This may also be undone by selecting the undo functionality.

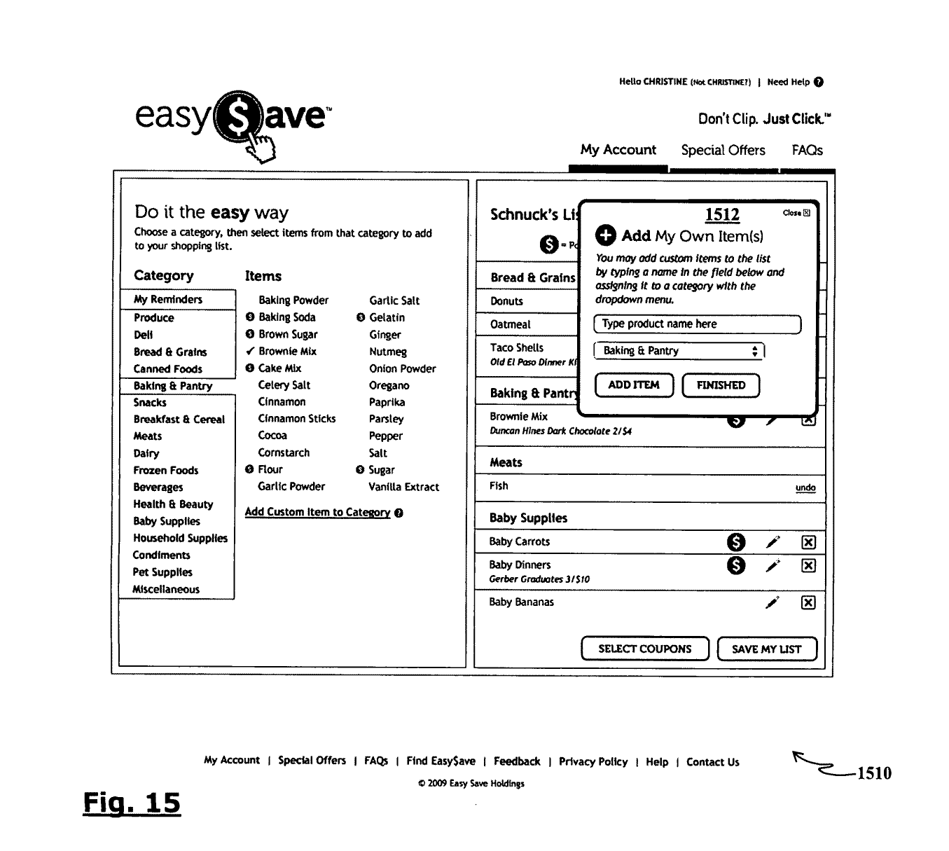

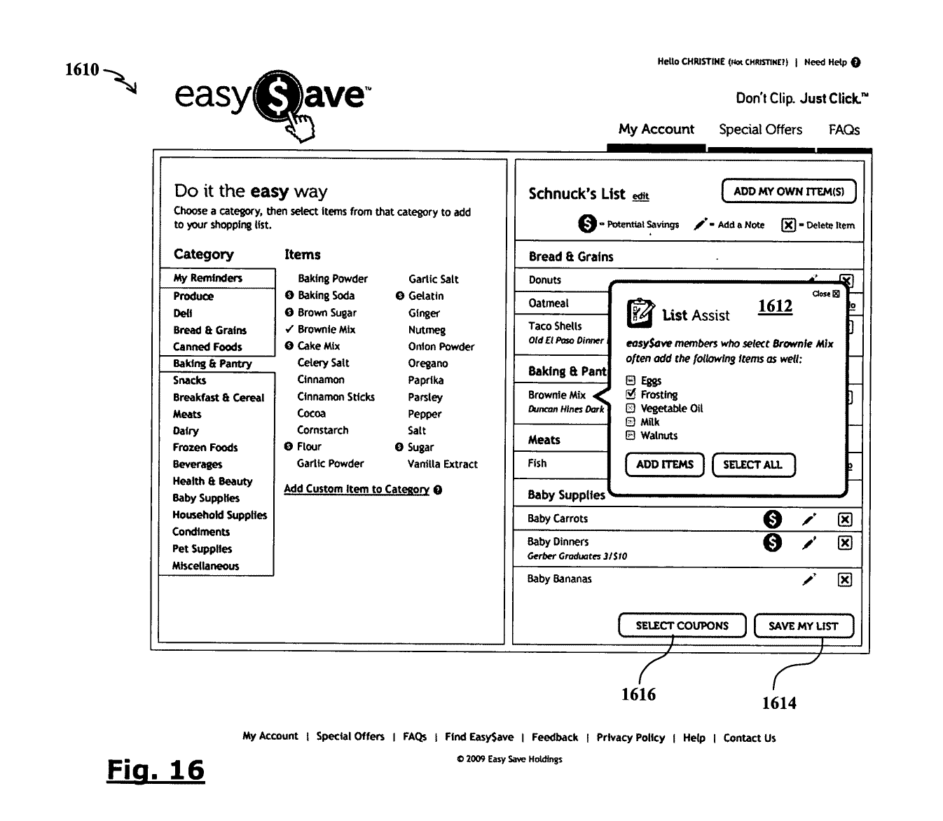

FIG. 15 shows a supplementary representation 1510 of the list creation/editing representation 1410 with the addition of a supplementary “Add my own item(s)” control 1512, enacted by selecting the “Add My Own Items” control 1428, for adding custom and/or unique items to the current list.

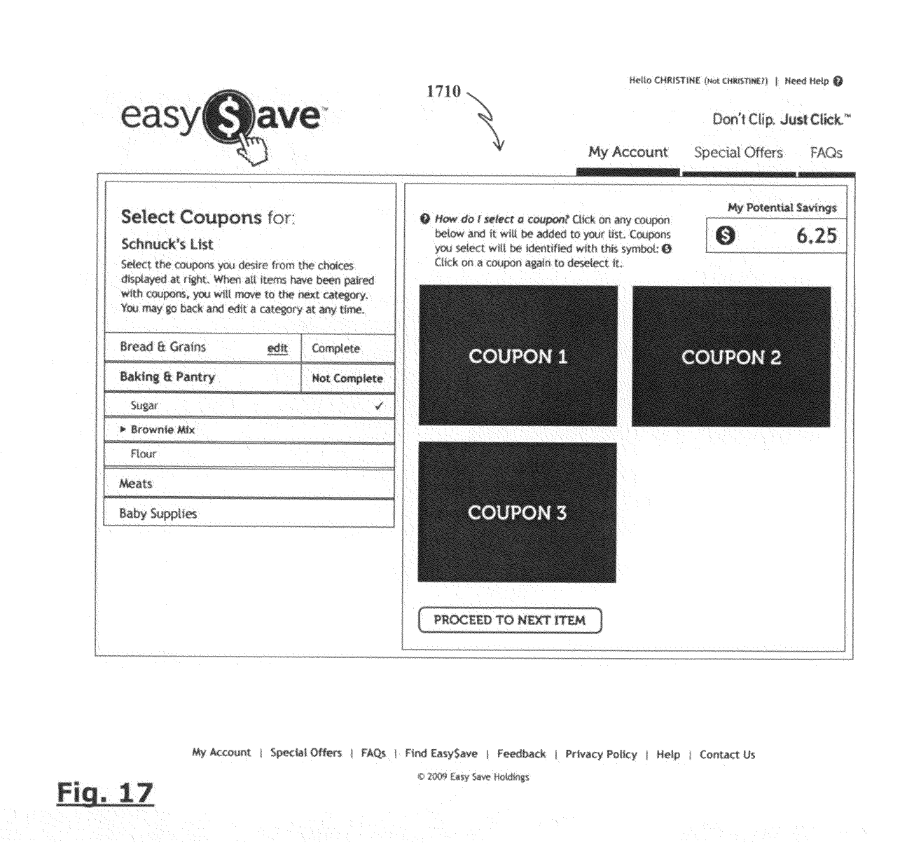

FIG. 16 shows a supplementary representation 1610 of the list creation/editing representation 1410 with the addition of a supplementary “List Assist” control 1612, for providing suggestions to Members that an item selected may also be usually associated with other items, such as to complete a recipe. Once the Member finishes creating and/or editing their list, they can choose to either Save My List 1614 or Select Coupons 1616 that are then assigned to the items on the present list. If Save My List 1614 is selected, then the list is saved and appears on the Dashboard 324. When Select Coupons 1616 is selected, the user is taken to a Coupon Selection/Assignment representation 1710.

FIG. 17 shows the Coupon Selection/Assignment representation 1710 that allows members to select coupons to be assigned to the items on their shopping list. The Coupon Selection/Assignment representation 1710 allows for selection among potentially several incentive options for each item. The coupon selection process involves:
a) Member is presented all item categories;
b) Beginning with the first category, items within that category are presented, and the coupons available for that item are presented at right. As the member moves through the items in the open category (items are presented in yellow, open category in dark green) the items that have been assigned with coupons will show up with a green check-mark in the right hand corner of their menu position;
c) The member may choose one or all of the coupons presented for the item, based on their preference;
d) When all coupons desired for that item are selected, the member then selects “Proceed to Next Item”; and
e) When all items in a category are selected, the navigation at left changes colors (dark green to light green) and the status at right reads “Complete.” If the Member wants to review or change their coupon selection(s) they can click on the “edit” link to re-open that category.

A user typically interacts with a kiosk according to the first retail consumer user embodiment of the present invention in accordance with a process that can involve:
a) Member arrives at a retail store and locates a kiosk;
b) The member gains access to their saved lists either via credit card entry, or by entering their username and password;
c) The kiosk presents the Member with all available lists, and allows selection of the appropriate list;
d) The member selects at least one list for use, and
   If all coupons currently available for items on that list have been selected/assigned, the kiosk generates a printed list;
   If there are new/additional coupons to choose from when the Member accesses the list at the kiosk, the system asks the member to review and make selections from the coupons and/or incentives now available;
   The Member can edit coupon selections at the kiosk; and
   The Member can add items from the “My Reminders” module to be combined with any list to create additional items for purchase.

### Additionally,

a) Members can choose to access only “My Reminder” items (ex: the Member is heading to a BBQ at a friend's house, and created a list on the fly via SMS that could be printed out and used for this mini-shopping experience. In this scenario, the Member would access the “My Reminders” items, and create a list at the kiosk, using the same interface and features available via the Web Site;
b) Once a list has been selected for printing, the kiosk prints out the list and generates a coupon/bar code specific to each item with potential savings assigned to it. The list generated can be organized congruently with an optimal and/or efficient walk-path for the Member, with the categories/items organized in the order that would be most advantageous for efficient gathering, based on the layout of the store so that the member can travel through the store easily, gathering items, and proceeding to checkout;
c) At checkout, the coupons associated with the list are normally scanned via currently available technology (such as bar codes and/or UPC scans); and
d) Coupon savings can be immediately applied to the total price for purchases, deducted from the bill, or the savings may be pushed into a savings account.

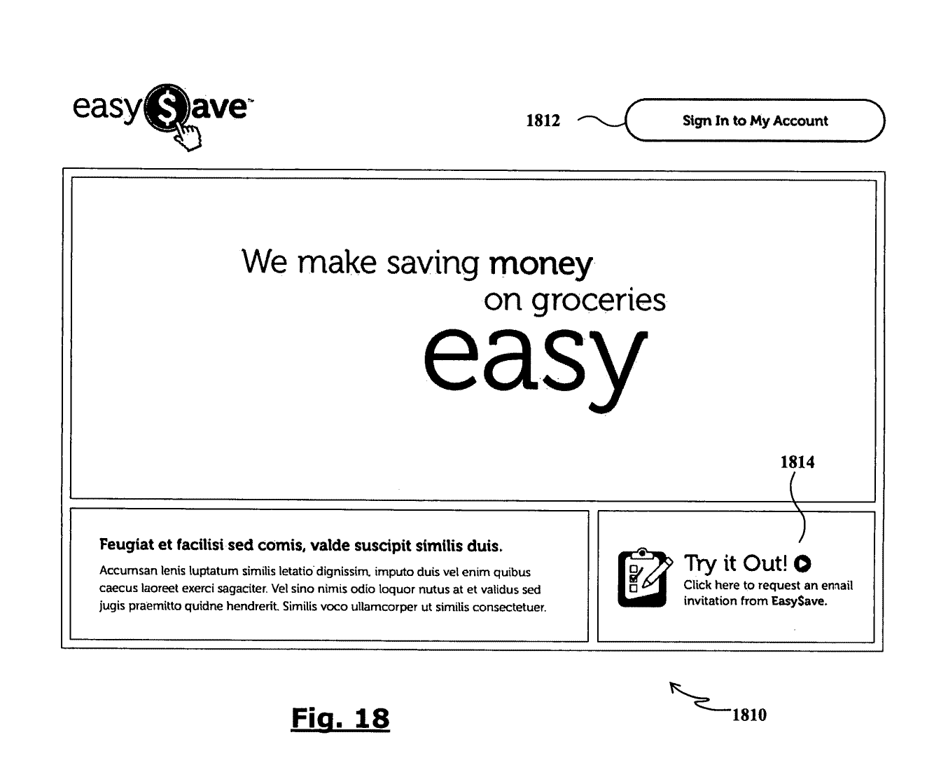

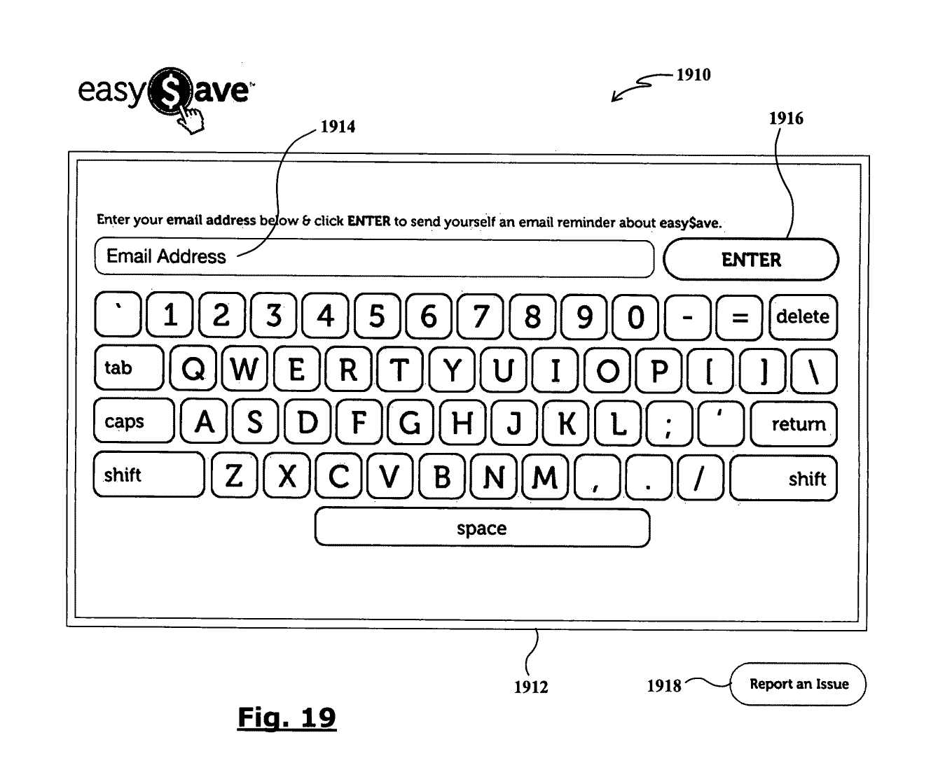

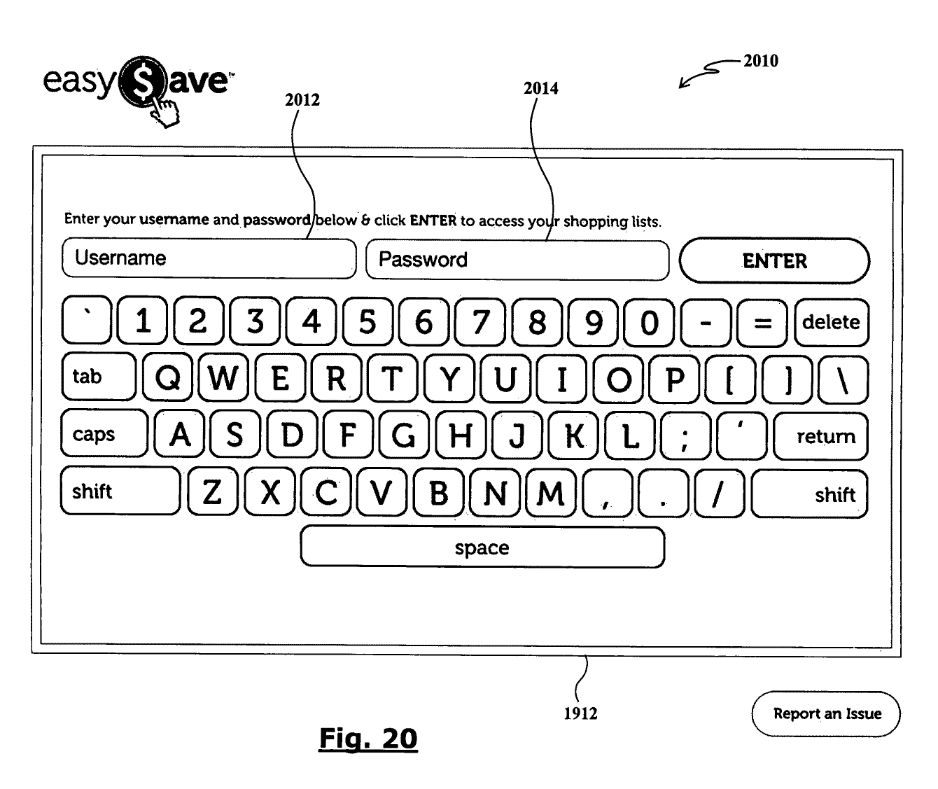

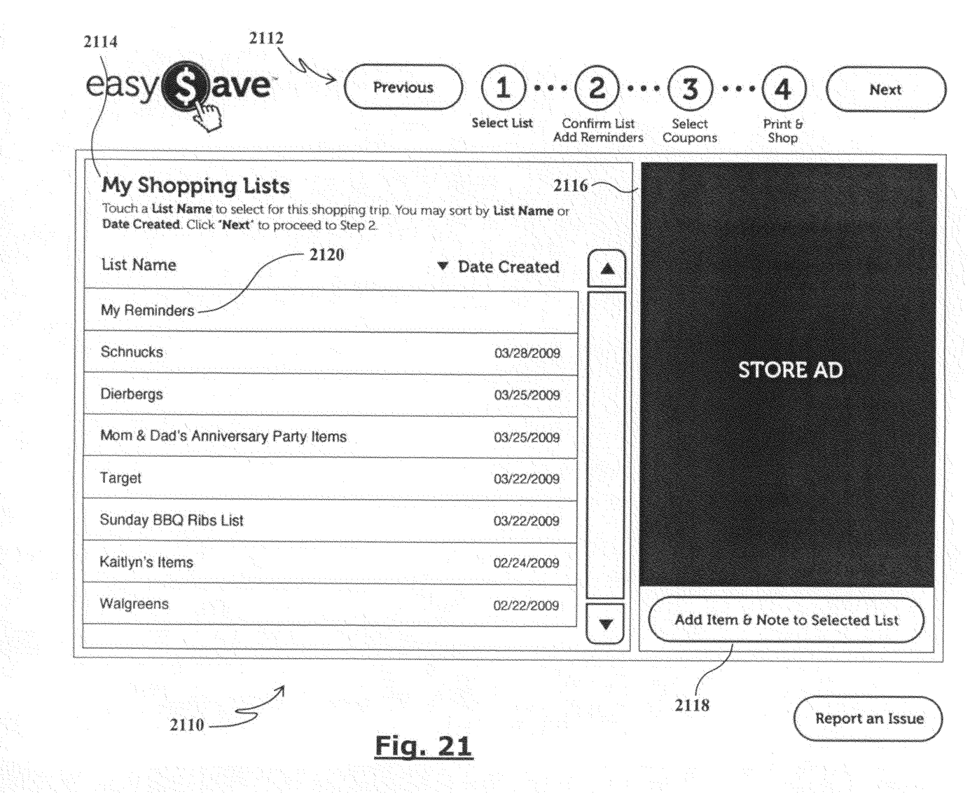

Kiosk users will usually be first shown, when encounter a kiosk according to the present invention, a transaction venue interface welcome screen 1810 as depicted in FIG. 18. In many instances, such as the first kiosk embodiment shown in FIG. 18, the kiosk user will be offered a limited number of welcome screen 1810 options to select from with only two being presented by the first kiosk embodiment. The first option, for current account holders, is to activate the “Sign In to My Account” access button 1812, while the second option, for those who do not yet hold accounts, is to activate the “Try it Out!” request invitation button 1814. The “Try it Out!” request invitation button 1814 sends the kiosk user to an Enter Invitation E-Mail Address screen 1910, whereas the “Sign In to My Account” access button 1812 sends kiosk users to a Sign In screen 2010. The Enter Invitation E-Mail Address screen 1910 shown in FIG. 19 is a representation of a keyboard 1912 (or a physical example thereof) that functions as a standard data entry keyboard and is utilized to enter an Email address 1914 where the kiosk user can receive a message with instructions how to sign up as an account holder in an embodiment of the present invention. Upon completing their use of the Email Address field 1914, the kiosk user sends the address by activating the “ENTER” key 1916. If a kiosk user needs or wants to enquire about an concern, a kiosk user would activate the “Report an Issue” button 1918 and an issue report field (not shown) would replace the Email address field 1914 and the kiosk user would utilize the keyboard 1912 to fill in and send their concern. The Sign In screen 2010 also includes the keyboard 1912 that is utilized to fill in the account holder's Username field 2012 and Password field 2014 which are entered to sign in to access an interaction facility to access the account administrator and their account.

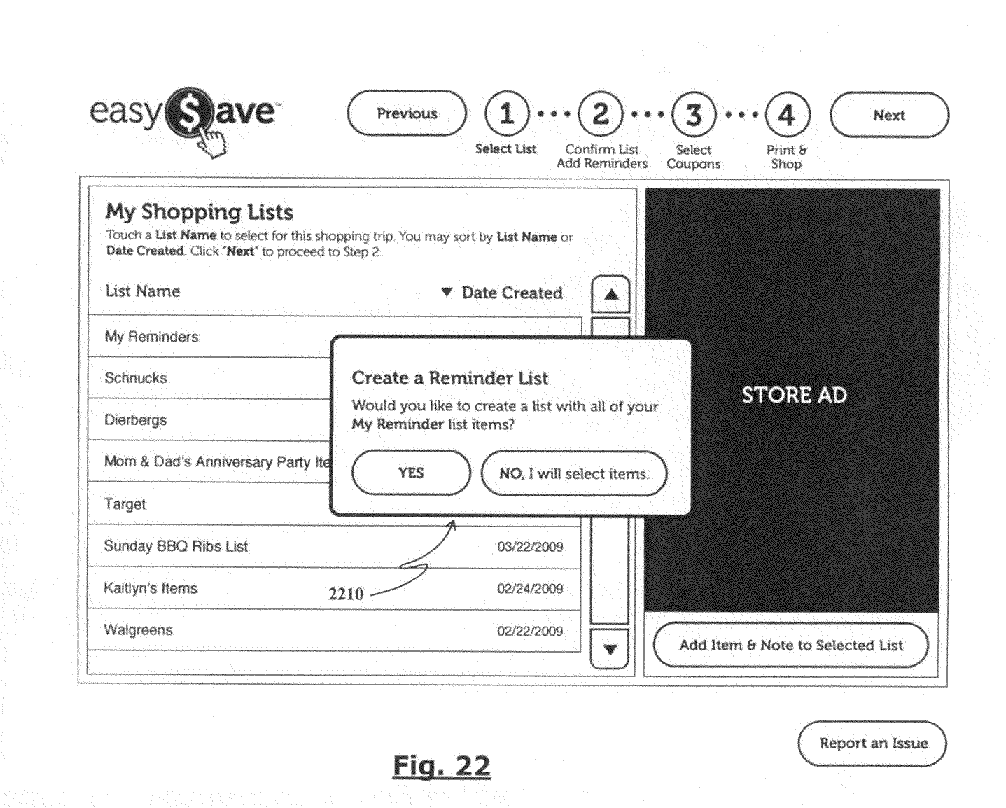

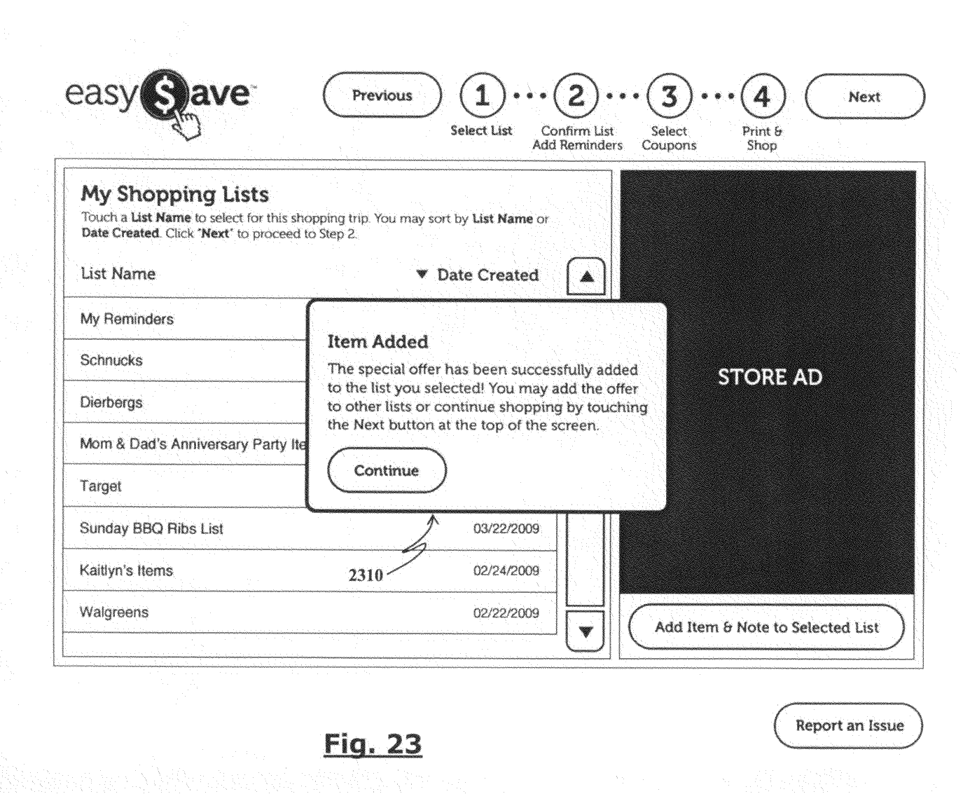

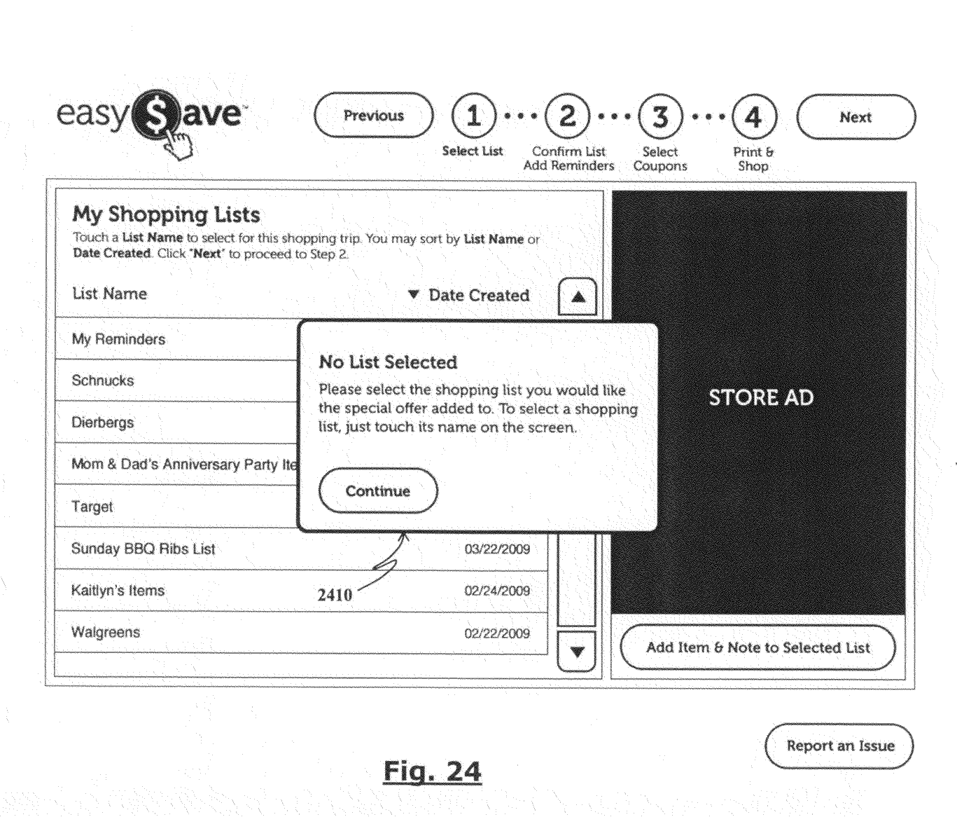

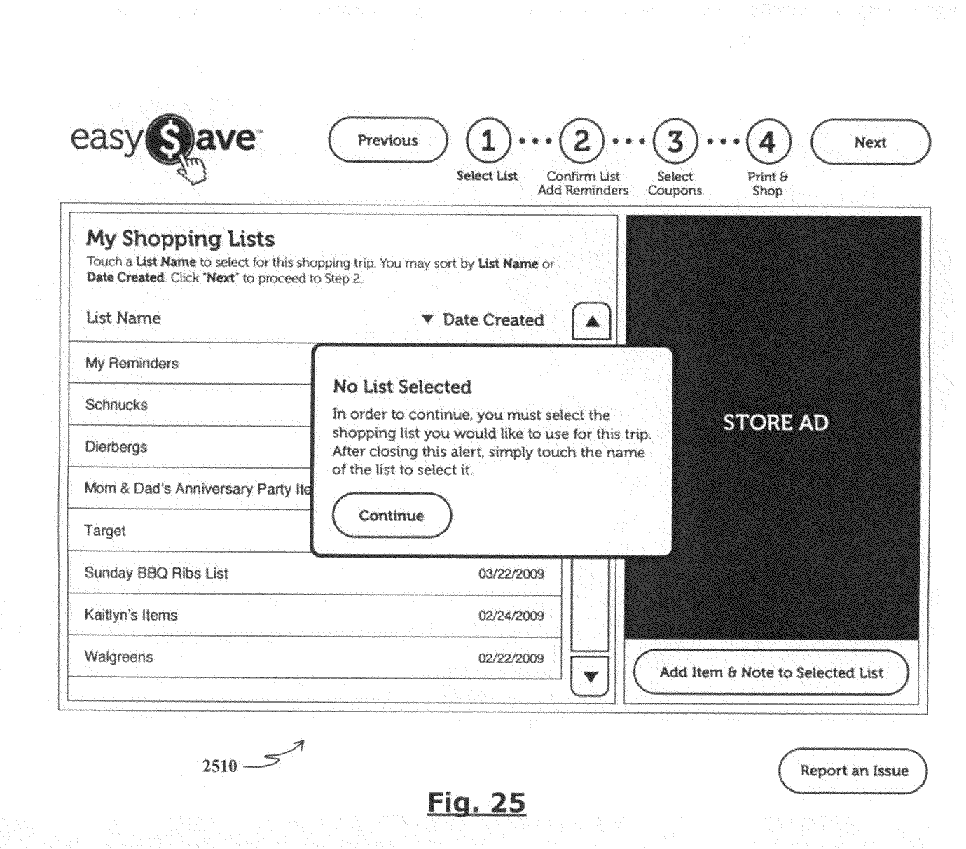

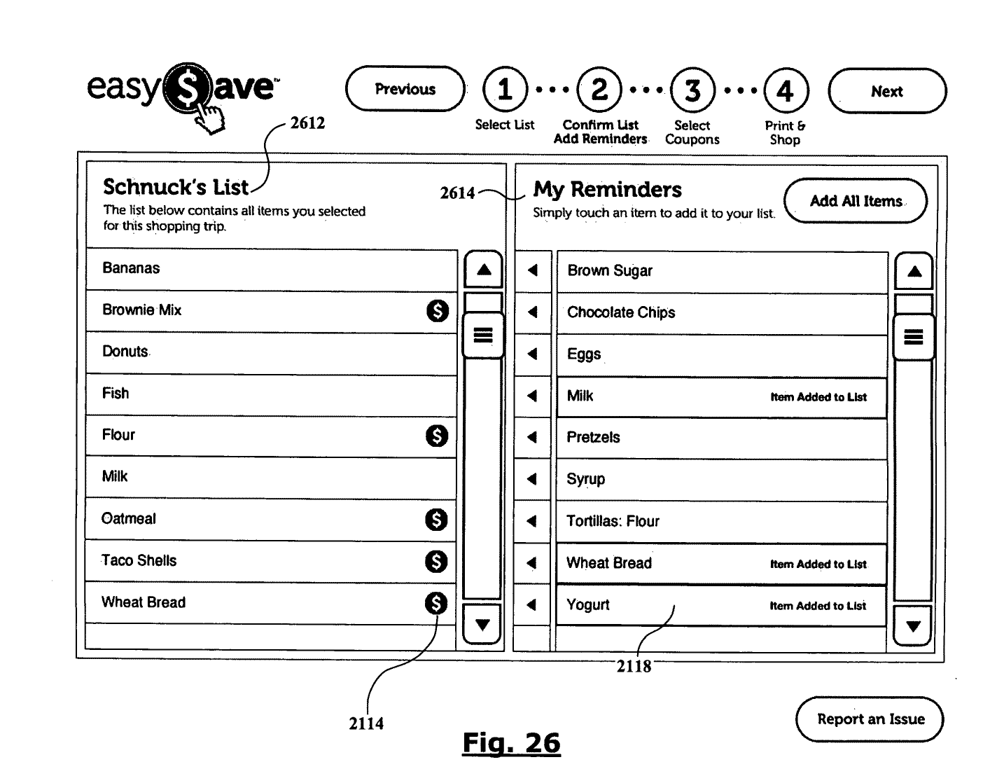

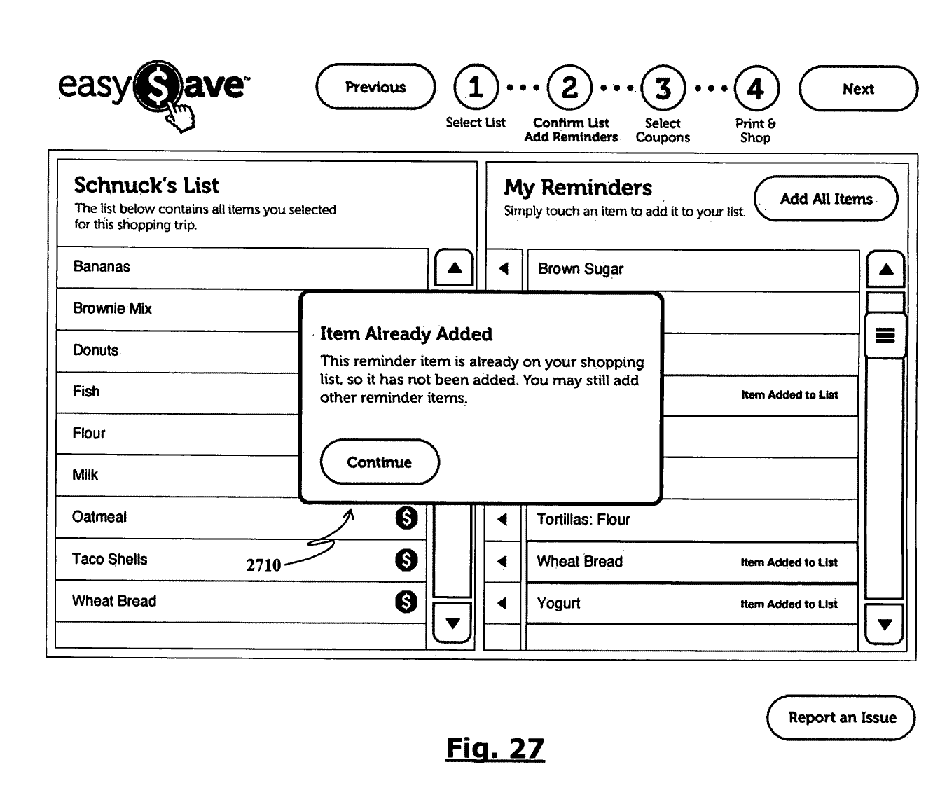

After signing in and accessing their account at the kiosk, the account holder will have a generally more limited set of options available to manage their account than are typically available over the web, since it will often be a priority to avoid long lines of users waiting for kiosks to become available. Hence, to ensure that users' kiosk usage times are condensed, the number of actions available to users using a kiosk will regularly also be condensed. Some options though, usually related to venue related usages like provisionings of projection and incentive compilations at a retail establishment, will often be available that are normally not a priority when account managing via home web access. These differences and similarities between the likely usage scenarios influences the differences and similarities between a kiosk dashboard 2110 and the (regularly web accessed) dashboard representation 1310. The kiosk dashboard 2110 is expected to be usually employed in standard sequences of operation, which are represented in stages by a progress indicator 2112. A My Shopping Lists field 2114 presents the primary optionality available to account holders when at the kiosk dashboard 2110, namely a choice among their compilations of projections and/or incentives, i.e. a shopping list, variously organized according to choices of the account holder. A “STORE AD” field 2116 will frequently present an advertisement that relates to the venue that the kiosk operates in conjunction with, while an Add Item button 2118 enables the account holder to include the advertised goods or service in a shopping list. Upon selecting a shopping list, and activating the progress indicator 2112 “Next” button, the kiosk user is then sent to stage 2 “Confirm List Add Reminders”. The account holder can make a new list by selecting the “My Reminders” list option 2114, including choosing less than all reminders and can also include new selections in an existing list. The choice between the inclusion of all the reminders and a subsection of the reminders is presented by the “Create a Reminder List” popup 2210 of FIG. 22. The choice of including the offer presented in the “STORE AD” field 2116 is confirmed by the “Item Added” popup 2310 of FIG. 23. An error message is transmitted by the “No List Selected” popup 2410 of FIG. 24, and a subsequent reinforcing error message is transmitted by the “Item Added” popup 2510 of FIG. 25, both messages refer to a kiosk users attempt to progress to the next stage without selecting a shopping list.

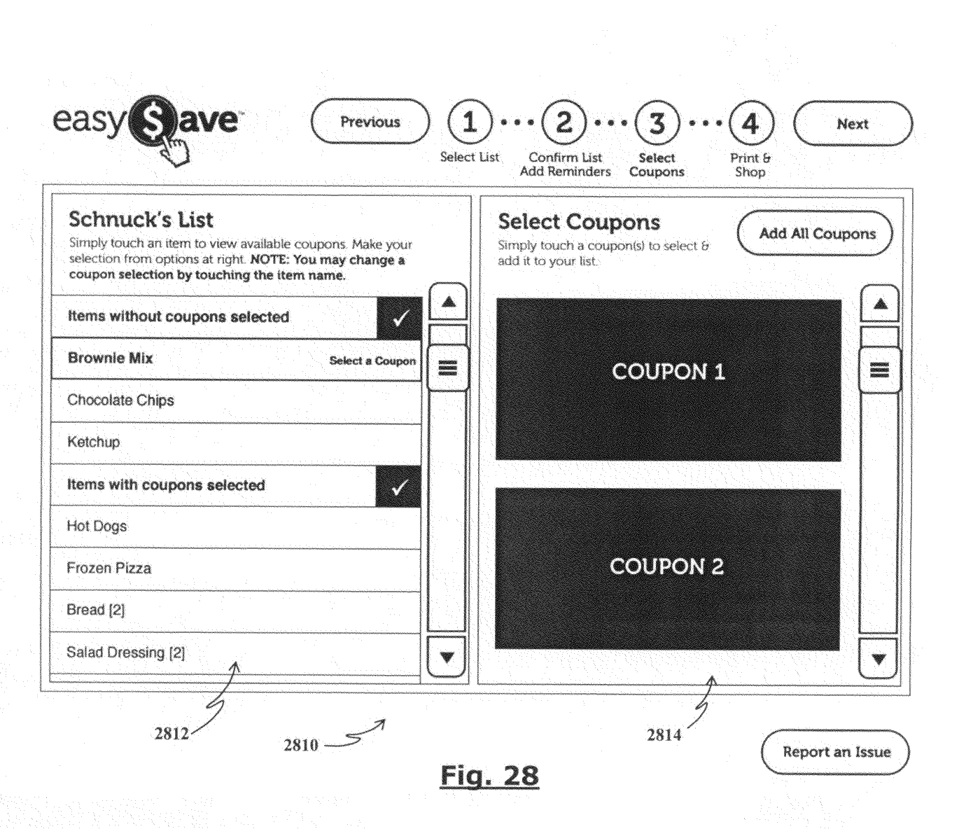

A kiosk usage scenario stage 2 List Review & Editing screen 2610 presents for reviewing and/or utilizing the selected list's contents 2612 alongside, for reviewing and/or utilizing, the My Reminders contents 2614. Within the contents of the selected list's contents 2612 can be one or more incentive indicators 2616. Much of the functionality presented by the List Review & Editing screen 2610 is similar in look and operation to a variety of the functions of the visual representation 1310 of the Dashboard 324 as depicted in FIG. 13. Similar appearing and arranged aspects of the List Review & Editing screen 2610 and the visual representation 1310 of the Dashboard 324 as depicted in FIG. 13 are generally equivalent in at least some attribute, and much of the explication of the visual representation 1310 of the Dashboard 324 as depicted in FIG. 13 is also applicable to the List Review & Editing screen 2610. An error possibility is communicated by the “Item Already Added” popup 2710 of FIG. 27. Additional options can also be presented (not shown) wherein the venue presents other options such as item suggestions, perhaps dynamically altering the choices presented.

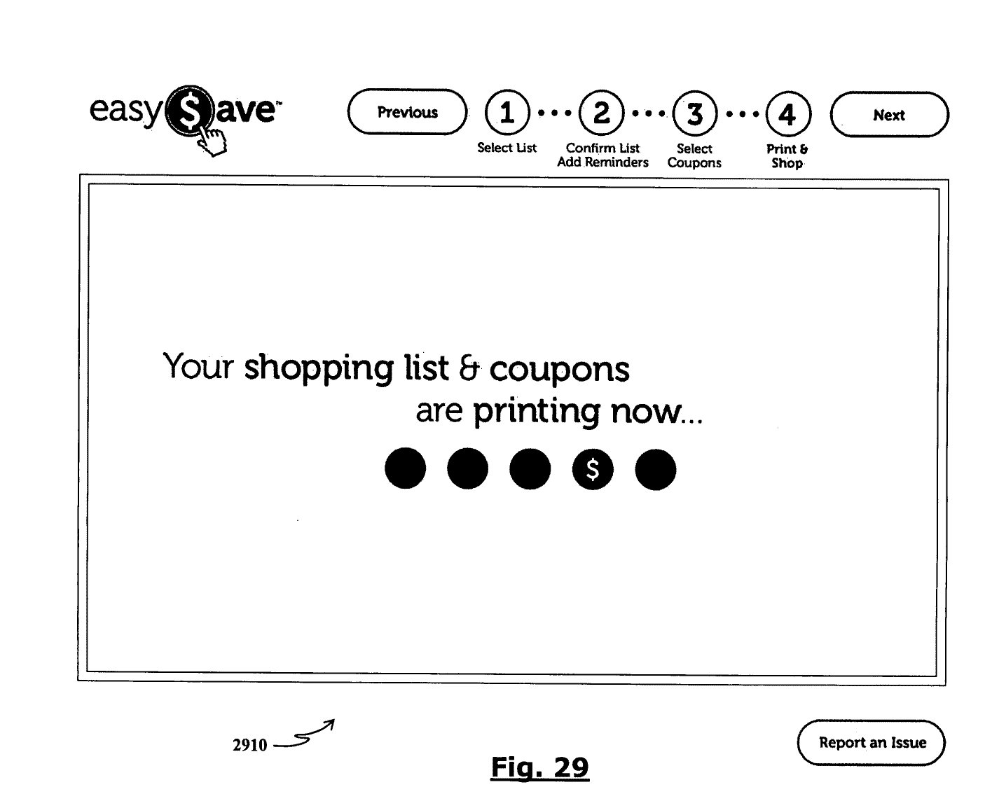

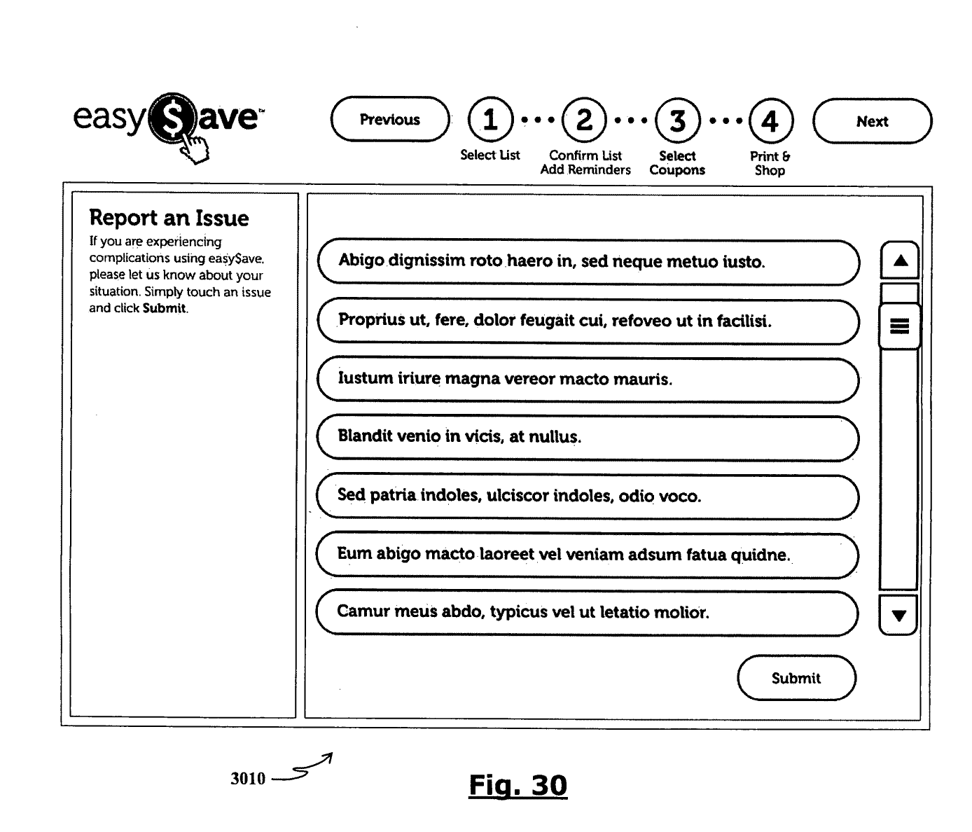

A Select Coupon screen 2810 depicted in FIG. 28 is generally presented to users at stage 3 of the typical kiosk usage scenario. The selected list's contents 2812 is presented in juxtaposition with projection incentives (coupons) applicable to each selected list item, with the applicable incentive contents 2814 presenting for selection the incentives applicable to the selected projection. When the kiosk is provisioning the compilation of projections and/or incentives, an informative screen “printing now” 2910 as depicted in FIG. 29 is displayed. Also available are non printing delivery options (not shown) such as wireless communication to a cell phone or the equivalent, or even automatic communication with a final transaction clearer (such as a checkout clerk) that may pre-settle the resolution of the transaction(s) prior to the account holder even beginning the transaction. When a user activates the “Report an Issue” button 1918 an Issue Report screen 3010 is presented with selections of messages to submit.

In view of the above, it will be seen that the various objects and features of the invention are achieved and other advantageous results obtained. The examples contained herein are merely illustrative and are not intended in a limiting sense.

What is claimed is:

1. A system for facilitating projected transactions comprising:
an account administrator that manages accounts, transaction projections, and transaction incentives, including managing by associating at least a first projection with at least a first account, and relating at least a first incentive to at least a first attribute of the at least a first projection, so that the at least a first incentive is associated with the at least a first account;
an interaction facility that accesses the account manager via both a first closed mode and a first open mode, the first closed mode involving at least a first venue interface interactive in conjunction with a first transaction venue, the first open mode involving at least a first discretionary interface, wherein an account holder can select the at least a first projection to be associated with the holder's account via the accessing of the account manager; and
at least a first provisioning facility, linked with the first venue interface, that provides the account holder a compilation of one or more projections and related incentives from the holder's account.

2. A system for facilitating projected transactions according to claim 1, further comprising one or more of:
(a) an incentive identifier that identifies one or more of the transaction incentives as related to the at least a first attribute of the first projection so that the identified related incentives are individually associable with the at least a first account;
(b) an account benefit comptroller, optionally integrated with the account administrator, that appraises incentive realization benefits and, optionally, aggregates one or more uncollected incentive realization benefits and, optionally, records the aggregated uncollected benefits; and
(c) a transaction projection assessor, optionally integrated with the account administrator, that assesses projections that are applicable to a transaction opportunity.

3. A system for facilitating projected transactions according to claim 1, wherein the at least a first attribute involves the at least a first projection's applicability to one or more transaction opportunities.

4. A system for facilitating projected transactions according to claim 3, wherein the at least a first incentive is also applicable to one or more of the at least a first projection applicable transaction opportunity.

5. A system for facilitating projected transactions according to claim 1, wherein the at least a first attribute involves the at least a first projection applicable transaction opportunities' proximity.

6. A system for facilitating projected transactions according to claim 1, wherein the at least a first attribute involves one or more patterns of one or more characteristics of the at least a first account associated projections, said patterns including projection histories and projection concurrences.

7. A system for facilitating projected transactions according to claim 1, wherein the at least a first attribute involves past or present realization statuses of one or more of the at least a first account associated projections.

8. A system for facilitating projected transactions according to claim 1, wherein the at least a first attribute is a temporal attribute.

9. A system for facilitating projected transactions according to claim 1, wherein the at least a first attribute is a cost-related attribute.

10. A system for facilitating projected transactions according to claim 1, wherein the at least a first attribute involves at least a first categorization aspect of the at least a first projection.

11. A system for facilitating projected transactions according to claim 1, wherein the first incentive is configurable to institute the relating to the at least a first attribute.

12. A system for facilitating projected transactions according to claim 1, wherein the at least a first attribute relates to one or more of the account holder's projection compilations.

13. A system for facilitating projected transactions according to claim 1, wherein the at least a first attribute relates to one or more of the provisionings of the account holder's projection compilations.

14. A system for facilitating projected transactions according to claim 1, wherein the at least a first venue interface involves a fixed interface that optionally resides within a kiosk.

15. A system for facilitating projected transactions according to claim 1, wherein the at least a first venue interface involves a touch screen.

16. A system for facilitating projected transactions according to claim 1, wherein the at least a first venue interface involves a predetermined portable interface.

17. A system for facilitating projected transactions according to claim 1, wherein the at least a first discretionary interface provides access via an account holder selected network accessing device.

18. A system for facilitating projected transactions according to claim 1, wherein the at least a first discretionary interface is Internet accessible.

19. A system for facilitating projected transactions according to claim 1, wherein the at least a first discretionary interface is at least partially provided by one or more software applications that can reside on discrete devices for utilization by account holders to access the interaction facility.

20. A system for facilitating projected transactions according to claim 1, wherein the at least a first discretionary interface is at least partially provided by one or more software applications that reside on collectively accessible websites for utilization by account holders to access the interaction facility.

21. A system for facilitating projected transactions according to claim 20, wherein the at least a first discretionary interface is accessed in conjunction with a web browser.

22. A system for facilitating projected transactions according to claim 1, wherein the at least a first provisioning facility provides at least a first representation of the selected compilation of projections and related incentives.

23. A system for facilitating projected transactions according to claim 22, wherein the at least a first representation has characteristics of a shopping list containing selected item procurement projections and one or more incentives related to one or more of the selected item procurement projections.

24. A method of facilitating projected transactions comprising the steps of:
managing accounts, transaction projections, and transaction incentives by associating at least a first projection with at least a first account, and relating at least a first incentive to at least a first attribute of the at least a first projection, so that the at least a first incentive is associated with the at least a first account;
accessing the managing by interacting with an interaction facility that is accessible via both a first closed mode and a first open mode, the first closed mode involving at least a first venue interface interactive in conjunction with a first transaction venue, the first open mode involving at least one discretionary interface, said accessing enabling an account holder to select the at least a first projection to be associated with the holder's account; and
providing the account holder a selected compilation of projections and related incentives from the holder's account via a provisioning facility linked with the first venue interface.

25. A method of facilitating projected transactions according to claim 24, comprising the step of providing one or more of (a) access to, (b) the functionality of, and (c) the utilization of a first specified service, said first specified service consisting of the implementation of the method of claim 24.

26. A transaction projection facilitating product produced according to the process of claim 24, said product embodying at least one of the functionality, functional utilization, functional benefit, and operative action of the process of claim 24.

27. A system for facilitating projected transactions comprising:
an account administrator that manages accounts, transaction projections, and transaction incentives, said managing including associating at least a first projection with a first account;
an interaction facility that accesses the account administrator via at least one of a first closed mode and a first open mode, said access enabling at least a first holder of the first account to select the at least a first projection for association with the first account;
an incentive identifier that identifies one or more incentives that relate to at least a first attribute of the at least a first projection so that the identified related incentives are individually associable, optionally by the account administrator, with the first account;
wherein the account administrator compiles at least a first set of one or more of the first account associated projections, the first set optionally also including one or more of the first account associable incentives.

28. A system for facilitating projected transactions according to claim 27, further comprising one or more of:
(a) one or more provisioning facilities, linked with the first venue interface, that provides the account holder a selected compilation of projections and related incentives from the holder's account;
(b) an account benefit comptroller, optionally integrated with the account administrator, that appraises incentive realization benefits and, optionally, aggregates one or more uncollected incentive realization benefits and, optionally, records the aggregated uncollected benefits; and
(c) a transaction projection assessor, optionally integrated with the account administrator, that assesses projections applicable to one or more transaction opportunities.

29. A system for facilitating projected transactions according to claim 27, wherein the first account holder selects the first projection for associating by at least partially specifying at least a first parameter of the first projection and, optionally, said account administrator implements the associating according to one or more first parameter featuring protocols.

30. A system for facilitating projected transactions according to claim 29, wherein the at least a first parameter is a prior first account association of the first projection, or one or more first projection correlated secondary projections.

31. A system for facilitating projected transactions according to claim 29, wherein the at least a first parameter involves a pattern of first account associated projections.

32. A system for facilitating projected transactions according to claim 29, wherein the at least a first parameter involves proximity to one or more transaction opportunities.

33. A system for facilitating projected transactions according to claim 29, wherein the at least a first parameter involves at least a first categorization aspect of the at least a first projection.

34. A system for facilitating projected transactions according to claim 29, wherein the at least a first parameter is a temporal parameter.

35. A system for facilitating projected transactions according to claim 29, wherein the at least a first parameter is a cost-related parameter.

36. A system for facilitating projected transactions according to claim 29, wherein the at least a first parameter relates to one or more of the account holder's projection compilations.

37. A system for facilitating projected transactions according to claim 29, wherein the at least a first parameter relates to one or more of the provisionings of the account holder's projection compilations.

38. A system for facilitating projected transactions according to claim 27, wherein the compilation of the first set projections involves an at least partial specification of at least a first parameter of the first account associated projections, said account administrator optionally implementing the compiling according to one or more first parameter featuring protocols.

39. A system for facilitating projected transactions according to claim 38, wherein the at least a first parameter involves a prior first account compilation of at least one of:
(a) the one or more first account associated projections;
(b) one or more secondary projections that correlate with one or more of the first set compiled projections;
(c) and combinations thereof.

40. A system for facilitating projected transactions according to claim 38, wherein the at least a first parameter involves a pattern of the first set compiled projections.

41. A system for facilitating projected transactions according to claim 38, wherein the at least a first parameter involves proximity to one or more transaction opportunities.

42. A system for facilitating projected transactions according to claim 38, wherein the at least a first parameter involves at least a first categorization aspect of the one or more first account associated projections.

43. A system for facilitating projected transactions according to claim 38, wherein the first parameter is a temporal parameter.

44. A system for facilitating projected transactions according to claim 38, wherein the first parameter is a cost-related parameter.

45. A system for facilitating projected transactions according to claim 38, wherein the at least a first parameter relates to one or more of the account holder's prior projection compilations.

46. A system for facilitating projected transactions according to claim 38, wherein the at least a first parameter relates to one or more of the account holder's prior projection compilation provisionings.

47. A system for facilitating projected transactions according to claim 27, wherein the compilation of the first set incentives involves an at least partial specification of at least a first parameter of the first account associable incentives, said account administrator optionally implementing the compiling according to one or more first parameter featuring protocols.

48. A system for facilitating projected transactions according to claim 47, wherein the at least a first parameter involves a prior first account compilation of at least one of:
(a) the one or more first account associable incentives;
(b) one or more secondary incentives that correlate with one or more of the first set compiled incentives;
(c) and combinations thereof.

49. A system for facilitating projected transactions according to claim 47, wherein the at least a first parameter involves a pattern of the first set compiled incentives.

50. A system for facilitating projected transactions according to claim 47, wherein the at least a first parameter involves proximity to one or more transaction opportunities.

51. A system for facilitating projected transactions according to claim 47, wherein the at least a first parameter involves at least a first categorization aspect of the one or more first account associable incentives.

52. A system for facilitating projected transactions according to claim 47, wherein the at least a first parameter is a temporal parameter.

53. A system for facilitating projected transactions according to claim 47, wherein the at least a first parameter is a cost-related parameter.

54. A system for facilitating projected transactions according to claim 47, wherein the at least a first parameter relates to one or more of the account holder's prior projection compilations.

55. A system for facilitating projected transactions according to claim 47, wherein the at least a first parameter relates to one or more of the account holder's prior projection compilation provisionings.

56. A system for facilitating projected transactions according to claim 27, wherein the incentive identifying involves an at least partial specification of at least a first parameter of one or more potentially related incentives, said account administrator optionally implementing the identifying according to one or more first parameter featuring protocols.

57. A system for facilitating projected transactions according to claim 56, wherein the at least a first parameter involves a prior identifying of at least one of:
(a) the one or more potentially related incentives;
(b) one or more secondary incentives that correlate with at least one of the one or more potentially related incentives
(c) and combinations thereof.

58. A system for facilitating projected transactions according to claim 56, wherein the at least a first parameter involves a pattern of relating to the at least a first attribute.

59. A system for facilitating projected transactions according to claim 56, wherein the at least a first parameter involves proximity to one or more transaction opportunities.

60. A system for facilitating projected transactions according to claim 56, wherein the at least a first parameter involves at least a first categorization aspect of the one or more potentially related incentives.

61. A system for facilitating projected transactions according to claim 56, wherein the at least a first parameter is a temporal parameter.

62. A system for facilitating projected transactions according to claim 56, wherein the at least a first parameter is a cost-related parameter.

63. A system for facilitating projected transactions according to claim 56, wherein the at least a first parameter relates to one or more prior projection and prior incentive associations.

64. A system for facilitating projected transactions according to claim 56, wherein the at least a first parameter relates to one or more prior projection and prior incentive compilations.

65. A system for facilitating projected transactions according to claim 27, wherein the incentive identifying incorporates incentive targeting, said targeting involving one or more prescribed incentives that are predirected to be related to at least one of the at least a first attribute.

66. A system for facilitating projected transactions according to claim 27, wherein the incentive identifying incorporates incentive tailoring, said tailoring involving one or more arranged incentives that are directed to be responsively related to at least one of the at least a first attribute.

67. A system for facilitating projected transactions according to claim 27, wherein the incentive identifying involves an at least partial specification of at least a first parameter of the identifiable incentives, said account administrator optionally implementing the identifying according to one or more first parameter featuring protocols.

68. A system for facilitating projected transactions according to claim 67, wherein the at least a first parameter involves a prior identifying of at least one of
(a) the one or more identifiable incentives;
(b) one or more secondary incentives that correlate with one or more of the identifiable incentives
(c) and combinations thereof.

69. A system for facilitating projected transactions according to claim 67, wherein the at least a first parameter involves a pattern of the identifiable incentives.

70. A system for facilitating projected transactions according to claim 67, wherein the at least a first parameter involves proximity to one or more transaction opportunities.

71. A system for facilitating projected transactions according to claim 67, wherein the at least a first parameter involves at least a first categorization aspect of the identifiable incentives.

72. A system for facilitating projected transactions according to claim 67, wherein the at least a first parameter is a temporal parameter.

73. A system for facilitating projected transactions according to claim 67, wherein the at least a first parameter is a cost-related parameter.

74. A system for facilitating projected transactions according to claim 67, wherein the at least a first parameter relates to one or more of the account holder's prior incentive identifications.

75. A system for facilitating projected transactions according to claim 67, wherein the at least a first parameter relates to one or more of the account holder's prior projection compilation provisionings.

76. A method of facilitating projected transactions comprising the steps of:
managing accounts, transaction projections, and transaction incentives, said managing including associating at least a first projection with a first account;
accessing said managing via at least one of a first closed mode and a first open mode, said accessing enabling a holder of the first account to select the at least a first projection for associating with the first account;
identifying one or more incentives that relate to at least a first attribute of the first projection, the identified related incentives being individually associable with the first account; and
compiling at least a first set of the first account associated projections that optionally further includes one or more of the first account associable incentives.

77. A method of facilitating projected transactions according to claim 76, further comprising the step of providing one or more of (a) access to, (b) the functionality of, and (c) the utilization of the method of claim 76.

78. A transaction projection facilitating product produced according to the process of claim 76, said product embodying at least one of the functionality, functional utilization, functional benefit, and operative action of the process of claim 76.

79. A system for facilitating projected transactions comprising:
an account administrator that manages accounts, transaction projections, and transaction incentives, said managing including associating at least a first projection with a first account and, optionally, further including one or more of,
identifying a selection of one or more incentives that relate to at least a first attribute of the first projection and associating at least one of the related incentives with the first account, and
compiling at least a first set of the first account associated projections that optionally also includes one or more of the first account associable incentives; and
an account benefit comptroller, optionally integrated with the account administrator, for appraising incentive realization benefits and, optionally,
aggregating one or more uncollected incentive realization benefits and, optionally,
recording one or more of the uncollected benefit aggregates.

80. A system for facilitating projected transactions according to claim 79, further comprising one or more of:
(a) an interaction facility that accesses the account administrator via at least one closed mode and at least one open mode, the at least one closed mode, in conjunction with at least one transaction venue, involving at least one interactive venue interface, the at least one open mode involving at least one discretionary interface, said account administrator access enabling an account holder to select projections to associate with their account;
(b) one or more provisioning facilities, linked with the first venue interface, that provides the account holder a selected compilation of projections and related incentives from the holder's account;
(c) an incentive identifier that identifies one or more of the transaction incentives as related to the at least a first attribute of the first projection so that the identified related incentives are individually associable with the at least a first account; and
(d) a transaction projection assessor, optionally integrated with the account administrator that assesses projections that are applicable to a transaction opportunity.

81. A system for facilitating projected transactions according to claim 79, wherein the appraising involves one or more projection related valuation metrics.

82. A system for facilitating projected transactions according to claim 79, wherein the appraising involves one or more incentive characterizations.

83. A system for facilitating projected transactions according to claim 79, wherein the aggregating involves one or more facets of one or more specific accounts.

84. A system for facilitating projected transactions according to claim 79, wherein the aggregating involves one or more incentive characterizations.

85. A system for facilitating projected transactions according to claim 79, wherein the recording involves one or more facets of one or more specific accounts.

86. A system for facilitating projected transactions according to claim 79, wherein the recording involves one or more incentive characterizations.

87. A method of facilitating projected transactions comprising the steps of:
managing accounts, transaction projections, and transaction incentives, said managing including, associating at least a first projection with a first account,
identifying a selection of incentives that relate to at least a first attribute of the first projection and associating at least one of the related incentives with the first account, and
compiling at least a first set of the first account associated projections, said first set further including at least a first portion of the first account related associable incentives; and
appraising incentive realization benefits and, optionally,
aggregating one or more uncollected incentive realization benefits and, optionally,
recording one or more of the benefit aggregates.

88. A method of facilitating projected transactions according to claim 87, further comprising the step of providing one or more of (a) access to, (b) the functionality of, and (c) the utilization of the method of claim 87.

89. A transaction projection facilitating product produced according to the process of claim 87, said product embodying at least one of the functionality, functional utilization, functional benefit, and operative action of the process of claim 87.

90. A system for assessing facilitated transaction projections comprising:
an account administrator that manages accounts, transaction projections, and transaction incentives, by associating at least a first projection with a first account,
identifying a selection of incentives that relate to at least a first attribute of the first projection and associating at least one of the related incentives with the first account, and
compiling at least a first set of the first account associated projections, said first set optionally further including at least a first portion of the first account related associable incentives; and
a transaction projection assessor, optionally integrated with the account administrator, that assesses one or more of the projections and incentives that are applicable to one or more transaction opportunities.

91. A system for assessing facilitated transaction projections according to claim 90 wherein the transaction projection assessor assesses one or more of the projections and incentives that are applicable to one or more transaction occurrences.

92. A system for assessing facilitated transaction projections according to claim 90 wherein one or more applicable transaction projections unrealized by the one or more transaction opportunities are assessed by the transaction projection assessor.

93. A system for assessing facilitated transaction projections according to claim 90 wherein one or more applicable transaction projections unrealized by one or more transaction occurrences are assessed by the transaction projection assessor.

94. A system for assessing facilitated transaction projections according to claim 90 wherein one or more applicable transaction incentives unrealized by the one or more transaction opportunities are assessed by the transaction projection assessor.

95. A system for assessing facilitated transaction projections according to claim 90 wherein one or more applicable transaction incentives unrealized by one or more transaction occurrences are assessed by the transaction projection assessor.

96. A system for assessing facilitated transaction projections according to claim 90 wherein the assessing involves actively sourced projection or incentive related information.

97. A system for assessing facilitated transaction projections according to claim 90 wherein the assessing involves passively sourced projection or incentive related information.

98. A system for assessing facilitated transaction projections according to claim 90 further comprising one or more of:
(a) an interaction facility that accesses the account administrator via at least one closed mode and at least one open mode, the at least one closed mode, in conjunction with at least one transaction venue, involving at least one interactive venue interface, the at least one open mode involving at least one discretionary interface, said account administrator access enabling an account holder to select projections to associate with their account;
(b) one or more provisioning facilities, linked with the first venue interface, that provides the account holder a selected compilation of projections and related incentives from the holder's account;
(c) an incentive identifier that identifies one or more of the transaction incentives as related to the at least a first attribute of the first projection so that the identified related incentives are individually associable with the at least a first account; and
(d) an account benefit comptroller, optionally integrated with the account administrator, for appraising incentive realization benefits and, optionally, aggregating one or more uncollected incentive realization benefits and, optionally, recording one or more of the uncollected benefit aggregates.

99. A method of assessing facilitated transaction projections comprising the steps of:
managing accounts, transaction projections, and transaction incentives by,
associating at least a first projection with a first account,
identifying a selection of incentives that relate to at least a first attribute of the first projection and associating at least one of the related incentives with the first account, and
compiling at least a first set of the first account associated projections, said first set optionally further including at least a first portion of the first account related associable incentives; and
assessing one or more of the projections that are applicable to one or more transaction opportunities.

100. A method of assessing facilitated transaction projections according to claim 99 wherein the assessing involves one or more of the transaction projections unrealized by one or more potentially applicable transaction occurrences.

101. A method of assessing facilitated transaction projections according to claim 99 wherein the assessing involves one or more of the transaction incentives unrealized by one or more potentially applicable transaction occurrences.

102. A method of assessing facilitated transaction projections according to claim 99 wherein the assessing involves actively sourced projection related information.

103. A method of assessing facilitated transaction projections according to claim 99 wherein the assessing involves passively sourced projection related information.

104. A method of facilitating projected transactions according to claim 99, further comprising the step of providing one or more of (a) access to, (b) the functionality of, and (c) the utilization of the method of claim 99.

105. A transaction projection facilitating product produced according to the process of claim 99, said product embodying at least one of the functionality, functional utilization, and operative action of the process of claim 99.

106. A system for facilitating projected transactions comprising:
an account administrator that associates one or more transaction projections with one or more accounts, one or more attributes of said one or more associated projections variously relating to one or more transaction incentives so that the one or more related incentives are associable, by the account administrator, with the one or more accounts associated with the incentive's related projections;
an interaction facility that accesses the account administrator via at least one closed mode and at least one open mode, the at least one closed mode, in conjunction with at least one transaction venue, involving at least one interactive venue interface, the at least one open mode involving at least one discretionary interface, said account administrator access enabling an account holder to select projections to associate with their account;
a provisioning facility, linkable with the first venue interface, that supplies a selected compilation of projections and related incentives from the holder's account;
an incentive identifier that identifies one or more of the transaction incentives as projection related so that the one or more projection related incentives and associated projections are individually compilable for optional inclusion in one or more sets by the account administrator;
an account benefit comptroller, optionally integrated with the account administrator, that assesses uncollected incentive realization benefits and, optionally, aggregates one or more of the uncollected benefits and, optionally, records the aggregated benefits; and
a transaction projection assessor, optionally integrated with the account administrator, that, once a transaction opportunity has occurred, assesses projections that are applicable to the transaction.

107. A system for facilitating projected transactions according to claim 106, wherein at least one of the interaction facility's at least one closed mode, the interaction facility's at least one open mode, or the entire interaction facility is optionally excludable or inoperative.

108. A system for facilitating projected transactions according to claim 106, wherein the provisioning facility is optionally excludable or inoperative.

109. A system for facilitating projected transactions according to claim 106, wherein the incentive identifier is optionally excludable or inoperative.

110. A system for facilitating projected transactions according to claim 10, wherein the account benefit comptroller is optionally excludable or inoperative.

111. A system for facilitating projected transactions according to claim 106, wherein the transaction projection assessor is optionally excludable or inoperative.

112. A method of facilitating projected transactions comprising the steps of:
associating one or more transaction projections with one or more accounts, and relating one or more transaction incentives to one or more attributes of the one or more associated projections, so that the one or more projection related incentives are associated with the one or more accounts;
accessing the one or more accounts, or the associated one or more projections or incentives, via at least one of one or more closed modes and one or more open modes of an interaction facility, a first open accessing mode involving one or more discretionary interfaces, a first closed accessing mode involving one or more venue interfaces interactive in conjunction with one or more transaction venues, at least one of the accessing modes enabling an account holder to select the one or more projections to be associated with the holder's account;
supplying the account holder a selected compilation of projections and related incentives from the holder's account via a provisioning facility linkable with the interaction facility;
identifying the one or more projection related transaction incentives so that the one or more associated projections and the one or more projection related incentives are individually compilable for optional inclusion in one or more sets;
appraising one or more uncollected incentive realization benefits and, optionally, aggregating one or more of the uncollected benefits and, optionally, recording the aggregated benefits; and
assessing transaction projections applicable to one or more transaction opportunities.

113. A method of facilitating projected transactions according to claim 112, wherein at least one of the interaction facility's at least one closed mode, the interaction facility's at least one open mode, or the entire interaction facility is optionally excludable or inoperative.

114. A method of facilitating projected transactions according to claim 112, wherein the provisioning facility is optionally excludable or inoperative.

115. A method of facilitating projected transactions according to claim 112, wherein the identifying of projection related transaction incentives is optionally excludable or inoperative.

116. A method of facilitating projected transactions according to claim 112, wherein the appraising of one or more uncollected incentive realization benefits is optionally excludable or inoperative.

117. A method of facilitating projected transactions according to claim 112, wherein the assessing of the transaction applicable projections is optionally excludable or inoperative.

118. A method of facilitating projected transactions according to claim 112, further comprising the step of assessing transaction incentives, once a transaction has occurred, that are applicable to the transaction.

119. A method of facilitating projected transactions according to claim 112, further comprising the step of providing one or more of (a) access to, (b) the functionality of, and (c) the utilization of the method of claim 112.

120. A transaction projection facilitating product produced according to the process of claim 112, said product embodying at least one of the functionality, functional utilization, and operative action of the process of claim 112.

121. A method of facilitating projected transactions comprising:
realizing a first process that includes sub-step (A) and two or more of sub-steps (B) through (H), wherein at least a part of one or more of the sub-steps (A) through (H) is optionally supplantable, said sub-steps (A) through (H) consisting of,
(A) associating one or more transaction projections with one or more accounts, and relating one or more transaction incentives to one or more attributes of the one or more associated projections, so that the one or more projection related incentives are associated with the one or more accounts;
(B) accessing the one or more accounts, or the associated one or more projections or incentives, via at least one of one or more closed modes and one or more open modes of an interaction facility, a first open accessing mode involving one or more discretionary interfaces, a first closed accessing mode involving one or more venue interfaces interactive in conjunction with one or more transaction venues, at least one of the accessing modes enabling an account holder to select the one or more projections to be associated with the holder's account;
(C) supplying the account holder a selected compilation of projections and related incentives from the holder's account via a provisioning facility linkable with the interaction facility;
(D) identifying the one or more projection related transaction incentives so that the one or more associated projections and the one or more projection related incentives are individually compilable for potential inclusion in one or more sets;
(E) assessing transaction projections, once a transaction has occurred, that are applicable to the transaction;
(F) appraising one or more uncollected incentive realization benefits;
(G) aggregating one or more of the uncollected incentive realization benefits;
(H) recording the aggregated uncollected incentive realization benefits;
said optional supplanting involving communicating surrogate information to substitute for occurrence of the supplanted at least a part of one or more of the sub-steps (A) through (H).

122. A method of facilitating projected transactions according to claim 121, further comprising supplanting, with the surrogate information communicating, the occurrence of the optionally supplantable at least a part of one or more of the sub-steps (A) through (H).

123. A method of facilitating projected transactions according to claim 122, wherein the supplanting involves engendering the substitutability, said engendering comprising one or more of preparing the surrogate information, sending the surrogate information, receiving the surrogate information, processing the surrogate information, responding to the surrogate information as an analogue to the supplanted occurrence, providing access to or accepting provision of the surrogate information, and treating the surrogate information as a substitute for the supplanted occurrence.

124. A method of facilitating projected transactions according to claim 121, further comprising the step of providing the functionality of utilization of the occurrence of the optionally supplantable at least a part of one or more of the sub-steps (A) through (H) to effect the substitution for the supplanted occurrence.

125. A transaction projection facilitating product produced according to the process of claim 121, said product embodying at least one of the functionality, functional utilization, and operative action of the process of claim 121.

126. A transaction projection facilitating product-by-process, said product-by-process consisting of a functionality of a process of facilitating transaction projections, said process comprising the step of associating one or more transaction projections with one or more accounts, and relating one or more transaction incentives to one or more attributes of the one or more associated projections, so that the one or more projection related incentives are associated with the one or more accounts; and further comprising one or more of the steps of:
(a) accessing the one or more accounts, or the associated one or more projections or incentives, via at least one of one or more closed modes and one or more open modes of an interaction facility, a first open accessing mode involving one or more discretionary interfaces, a first closed accessing mode involving one or more venue interfaces interactive in conjunction with one or more transaction venues, at least one of the accessing modes enabling an account holder to select the one or more projections to be associated with the holder's account;
(b) supplying the account holder a selected compilation of projections and related incentives from the holder's account via a provisioning facility linkable with the interaction facility;
(c) identifying the one or more projection related transaction incentives so that the one or more associated projections and the one or more projection related incentives are individually compilable for optional inclusion in one or more sets;
(d) appraising one or more uncollected incentive realization benefits and, optionally, aggregating one or more of the uncollected benefits and, optionally, recording the aggregated benefits; and
(e) assessing transaction projections applicable to one or more transaction opportunities.
